(19) United States
(12) Patent Application Publication
(10) Pub. No.: US 2026/0323666 A1
(43) Pub. Date: Oct. 15, 2026

(54) SIDELINK POSITIONING USING BANDWIDTH AGGREGATION

(71) Applicant: Lenovo (Singapore) Pte. Limited, Singapore (SG)

(72) Inventors: Robin Rajan Thomas, Bad Nauheim (DE); Karthikeyan Ganesan, Nauheim (DE)

(73) Assignee: Lenovo (Singapore) Pte. Limited, Singapore (SG)

(21) Appl. No.: 19/485,089

(22) PCT Filed: May 17, 2024
(86) PCT No.: PCT/IB2024/054824

§ 371 Date: Nov. 17, 2025

Related U.S. Application Data
(60) Provisional application No. 63/467,778, filed on May 19, 2023.
(60) Provisional application No. 63/503,199, filed on May 19, 2023.

(51) Int. Cl. H04W 72/25; H04L 5/00; H04W 72/044

(52) U.S. Cl. CPC H04W 72/25; H04L 5/0098; H04W 72/044

(57) ABSTRACT

Various aspects of the present disclosure relate to methods, apparatuses, and systems that support sidelink positioning using bandwidth aggregation. For instance, implementations provide descriptions of transmission characteristics and scenarios in which sidelink positioning reference signal (SL-PRS) may be aggregated as well as scenarios to support SL-PRS frequency hopping. Further, configuration parameters are provided for configuring a receiving user equipment (UE) and/or measurement UE to perform SL-PRS aggregation and/or frequency hopping. The described techniques also enable the SL-PRS bandwidth aggregation and frequency hopping features via activation and deactivation (e.g., release) signaling indications.

### RELATED APPLICATION

This application claims priority to U.S. Provisional Application Ser. No. 63/503,199 filed May 19, 2023 entitled “Aggregated Positioning Measurements and Reporting,” the disclosure of which is incorporated by reference herein in its entirety. This application also claims priority to U.S. Provisional Application Ser. No. 63/467,778 filed May 19, 2023 entitled “Sidelink Positioning Using Bandwidth Aggregation,” the disclosure of which is incorporated by reference herein in its entirety.

### TECHNICAL FIELD

The present disclosure relates to wireless communications, and more specifically to device positioning.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for determining device position, such as a location of a UE. However, current device position techniques may be imprecise and result in inaccurate indications of device location.

### SUMMARY

The present disclosure relates to methods, apparatuses, and systems that support sidelink positioning using bandwidth aggregation. For instance, implementations provide descriptions of transmission characteristics and scenarios in which sidelink positioning reference signal (SL-PRS) may be aggregated as well as scenarios to support SL-PRS frequency hopping. Further, configuration parameters are provided for configuring a receiving UE and/or measurement UE to perform SL-PRS aggregation and/or frequency hopping. The described techniques also enable SL-PRS bandwidth aggregation and frequency hopping features via activation and deactivation (e.g., release) signaling indications.

Thus, by utilizing the described techniques, increased accuracy for sidelink device positioning can be achieved. For instance, the described techniques can enhance sidelink positioning accuracy and support sidelink positioning in scenarios that involve limited bandwidths.

Some implementations of the methods and apparatuses described herein may further include receiving a trigger event to perform SL-PRS bandwidth aggregation; generating an aggregated bandwidth based at least in part on an availability of time-frequency resources available to aggregate SL-PRS resources and based at least in part on the aggregated bandwidth corresponding to one or more conditions, the one or more conditions including at least one same SL-PRS configuration across different sidelink carriers; and transmitting SL-PRS with the aggregated bandwidth.

Some implementations of the methods and apparatuses described herein may further include receiving the trigger event from one or more higher layers; where the trigger event includes a message from at least one internal higher layer of an apparatus, the at least one internal higher layer of the apparatus including one or more of a media access control (MAC) control element (CE), a PC5 radio resource control (RRC) layer, a sidelink positioning protocol layer, a vehicle to everything (V2X) layer, a proximity services (ProSe) layer, or an application layer; where the trigger event includes a message from one or more of a gNB, a location server, an anchor user equipment (UE), a positioning reference unit (PRU) UE, a server UE, client UE, or a target UE; determining the availability of the time-frequency resources to aggregate SL-PRS based at least in part on configuration information received from a network entity, the network entity including a gNB, a location server, or a user equipment (UE).

Some implementations of the methods and apparatuses described herein may further include determining the availability of the time-frequency resources to aggregate SL-PRS based at least in part on a preconfiguration of an apparatus; where the at least one same SL-PRS configuration includes one or more of overlapping symbols from different sidelink carriers, different sidelink bandwidth parts (BWP), different sidelink Resource Pools, aligned periodicities across the different sidelink carriers, aligned sidelink PRS slot offsets across the different sidelink carriers, aligned comb-sizes, or aligned muting pattern; where the aggregated bandwidth is applicable to one or more of intra-band contiguous sidelink carriers, intra-band non-contiguous sidelink carriers, or inter-band sidelink carriers; where the trigger event causes transmission of a SL-PRS aggregated bandwidth on-demand request; further including generating the aggregated bandwidth based on one or more of sidelink carrier level, sidelink BWP level, sidelink dedicated resource pool level, sidelink shared resource pool level, or sidelink PRS resource level.

Some implementations of the methods and apparatuses described herein may further include determining an availability of a plurality of time-frequency resources available to perform one or more of transmit frequency positioning reference signal hopping or receive frequency positioning reference signal hopping and based at least in part on a received configuration; receiving a second trigger event from one or more higher layers to perform the one or more of the transmit frequency positioning reference signal hopping or the receive frequency positioning reference signal hopping; where the received configuration includes one or more of a resource granularity of hops, a time gap between one or more of consecutive hops or non-consecutive hops, a number of hops, a start physical resource block (PRB) of hops, or a start sub-channel of hops; the resource granularity of hops includes one or more of SL-PRS resource, SL-PRS resource set, SL-PRS dedicated or shared resource pool, sidelink BWP, or sidelink carrier; where a subset of parameters within the at least one same SL-PRS configuration across different sidelink carriers is the same, and where the subset of parameters includes a part of the one or more conditions.

Some implementations of the methods and apparatuses described herein may further include transmitting activation signaling to activate SL-PRS resources for transmitting SL-PRS for bandwidth aggregation; and transmitting deactivation signaling to deactivate the activated SL-PRS resources.

Some implementations of the methods and apparatuses described herein may further include: where operations are performed by an apparatus, and the apparatus includes one or more of a network entity or a user equipment (UE); transmitting at least one of the activation signaling or the deactivation signaling via one or more of lower layer signaling or higher layer signaling.

Some implementations of the methods and apparatuses described herein may further include receiving activation signaling to activate SL-PRS resources for transmitting SL-PRS for bandwidth aggregation; transmitting, based at least in part on the activation signaling, SL-PRS via an aggregated bandwidth; and receiving deactivation signaling to deactivate the activated sidelink PRS resources.

Some implementations of the methods and apparatuses described herein may further include receiving at least one of the activation signaling or the deactivation signaling via one or more of lower layer signaling or higher layer signaling.

Some implementations of the methods and apparatuses described herein may further include transmitting a trigger event to perform SL-PRS bandwidth aggregation; receiving SL-PRS via an aggregated bandwidth, the aggregated bandwidth corresponding to at least one same SL-PRS configuration across different sidelink carriers; and performing aggregated SL-PRS positioning measurements based on the received configuration.

Some implementations of the methods and apparatuses described herein may further include transmitting the trigger event via higher layer signaling; transmitting the trigger event via one or more of a MAC CE, PC5 RRC signaling, sidelink positioning protocol signaling, vehicle to everything (V2X) signaling, proximity services (ProSe) signaling, or application signaling; the method is performed by an apparatus, and the apparatus includes one of a gNB, a location server, an anchor user equipment (UE), a PRU UE, a server UE, or a target UE; transmitting configuration information for determining availability of time-frequency resources for aggregating SL-PRS.

Some implementations of the methods and apparatuses described herein may further include transmitting configuration information for determining an availability of a plurality of time-frequency resources available to perform one or more of transmit frequency positioning reference signal hopping or receive frequency positioning reference signal hopping; transmitting a second trigger event to perform the one or more of the transmit frequency positioning reference signal hopping or the receive frequency positioning reference signal hopping; where the configuration information includes one or more of a resource granularity of hops, a time gap between one or more of consecutive hops or non-consecutive hops, a number of hops, a start physical resource block (PRB) of hops, or a start sub-channel of hops.

### BRIEF DESCRIPTION OF THE DRAWINGS

FIG. 1 illustrates an example of a wireless communications system that supports sidelink positioning using bandwidth aggregation in accordance with aspects of the present disclosure.

FIG. 2 illustrates an example of a system for NR beam-based positioning as related to aggregated positioning measurements and reporting in accordance with aspects of the present disclosure.

FIG. 3 illustrates an example of absolute and relative positioning scenarios as related to aggregated positioning measurements and reporting in accordance with aspects of the present disclosure.

FIG. 4 illustrates an example of a multi-cell round trip time (RTT) procedure as related to aggregated positioning measurements and reporting in accordance with aspects of the present disclosure.

FIG. 5 illustrates an example of a system for relative range estimation using a gNB RTT positioning framework as related to aggregated positioning measurements and reporting in accordance with aspects of the present disclosure.

FIGS. 6-8 illustrate examples of procedures to perform measurement configuration and reporting based on aggregated positioning measurements, as related to aggregated positioning measurements and reporting in accordance with aspects of the present disclosure.

FIGS. 9-11 illustrate examples of procedures to perform measurement configuration and reporting based on SL-PRS aggregated positioning measurements, as related to aggregated positioning measurements and reporting in accordance with aspects of the present disclosure.

FIGS. 12 and 13 illustrate examples of procedures for request and response signaling for aggregated positioning measurement and processing, as related to aggregated positioning measurements and reporting in accordance with aspects of the present disclosure.

FIGS. 14-18 illustrate example scenarios that support sidelink positioning using bandwidth aggregation in accordance with aspects of the present disclosure.

FIGS. 19 and 20 illustrate example procedures that support sidelink positioning using bandwidth aggregation in accordance with aspects of the present disclosure.

FIG. 21 illustrates an example block diagram of devices that support sidelink positioning using bandwidth aggregation in accordance with aspects of the present disclosure.

FIGS. 22-25 illustrate flowcharts of methods that support sidelink positioning using bandwidth aggregation in accordance with aspects of the present disclosure.

### DETAILED DESCRIPTION

In wireless communications systems, positioning frameworks have been proposed which enable Uu interface UE-assisted and UE-based positioning methods. However, in such frameworks there is currently a lack of support for efficient UE-to-UE range and orientation determination, which can be important to support relative positioning services and applications across different vertical services, e.g., V2X, public safety, IIoT, commercial cases, etc. Based on the ongoing specification work, sidelink positioning may support a variety of RAT-dependent positioning techniques including but not limited to SL-TDoA, SL-RTT, and SL-AoA. Each of the aforementioned SL positioning techniques may involve a set of distributed UEs participating in a SL positioning session, which may be in-coverage, partial coverage and out-of-coverage. However, intelligent transport systems (ITS) bands used in the V2X scenarios may have limited bandwidths in the order of 20 MHz and 40 MHz, which can impact the measurement accuracy and thus the overall SL positioning accuracy. Procedures and mechanisms are therefore required to enable aggregation of multiple carriers to improve time domain resolution of received SL-PRS signals for enhance location estimation.

Accordingly, this disclosure provides for techniques that support sidelink positioning using bandwidth aggregation. For instance, implementations provide ways for enhanced sidelink mechanisms and procedures to enable aggregation of one or more carriers that include SL-PRS. The described techniques, for example, consider how conditions under which SL-PRS carrier aggregation may occur may affect positioning accuracy. Further, resource hierarchy of different aggregated SL-PRS resources are considered. Still further, support is provided for activation and release signaling for bandwidth aggregation.

In implementations, the describe techniques detail transmission characteristics and scenarios in which SL-PRS may be aggregated as well as scenarios to support SL-PRS frequency hopping. Further, configuration parameters are provided for configuring a receiving UE and/or measurement UE to perform SL-PRS aggregation and/or frequency hopping. The described techniques also enable the SL-PRS bandwidth aggregation and frequency hopping features via activation and deactivation (e.g., release) signaling indications.

Thus, by utilizing the described techniques, increased accuracy for sidelink device positioning can be achieved. For instance, the described techniques can enhance sidelink positioning accuracy and support sidelink positioning in scenarios that involve limited bandwidths.

Aspects of the present disclosure are described in the context of a wireless communications system. Aspects of the present disclosure are further illustrated and described with reference to device diagrams and flowcharts.

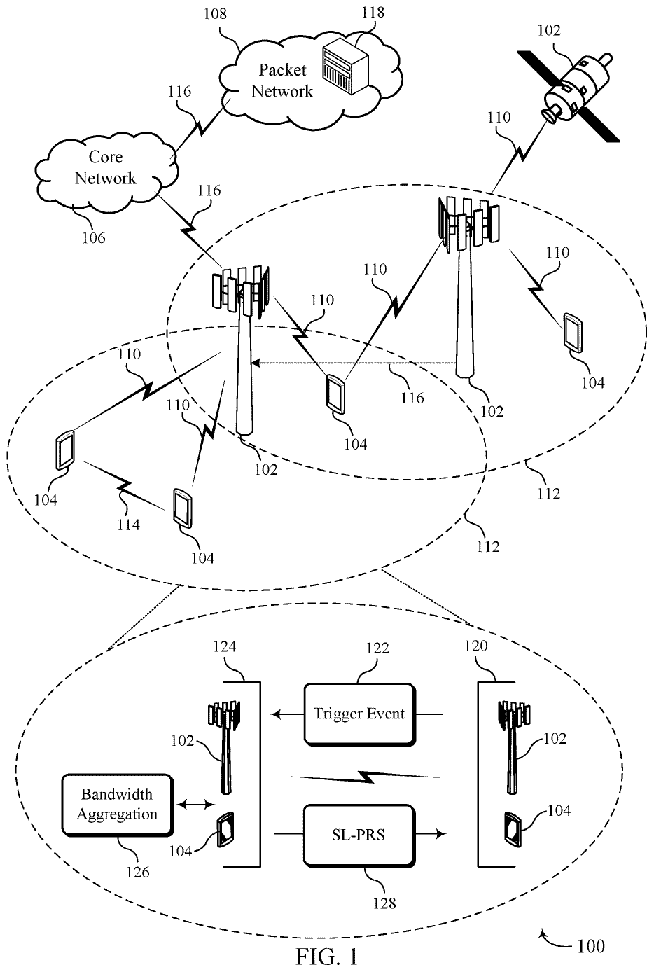

FIG. 1 illustrates an example of a wireless communications system 100 that supports sidelink positioning using bandwidth aggregation in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for sidelink positioning using bandwidth aggregation, a measurement entity 120 generates a trigger event 122 and transmits the trigger event 122 to a configuration entity 124. The measurement entity 120 may be implemented in various ways, such as a network node (e.g., gNB), a UE, and so forth. Various examples of measurement entities are described throughout this disclosure and illustrated in the accompanying figures. The trigger event 122, for instance, represents a trigger event to perform SL-PRS bandwidth aggregation. The configuration entity 124 receives the trigger event 122 and performs bandwidth aggregation 126 based at least in part on the trigger event 122. The bandwidth aggregation 126, for instance, utilizes available time-frequency resources to aggregate SL-PRS resources and is based at least in part on an aggregated bandwidth corresponding to one or more conditions. The conditions, for instance, include at least one same SL-PRS configuration across different sidelink carriers. The configuration entity 124 can be implemented in various ways, such as a network node (e.g., gNB), a UE, and so forth. Various examples of configuration entities are described throughout this disclosure and illustrated in the accompanying figures.

The configuration entity 124 then transmits SL-PRS 128 to the measurement entity 120 and using an aggregated bandwidth generated via the bandwidth aggregation 126. The measurement entity 120 can utilize the transmitted SL-PRS 128 to perform various positioning tasks for a positioning target device (e.g., target UE), such as to perform aggregated SL-PRS positioning measurements based on a received configuration.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIoT |
|---|---|---|
| Horizontal Positioning | (<1 m) for 90% of UEs | (<0.2 m) for 90% of UEs; |
| Vertical Positioning | (<3 m) for 90% of UEs | (<1 m) for 90% of UEs |
| Physical layer latency for | (<10 ms) | (<10 ms) |
| position estimation of UE | | |
| End-to-End Latency for | (<100 ms) | (<100 ms, in the order of |
| position estimation of UE | | 10 ms is desired) |

For sidelink positioning in Release 18, various requirements were defined capturing a variety of use cases, as listed in the Table T1, below:

TABLE T1

| SL | | | | |
|---|---|---|---|---|
| Positioning | | | | |
| KPIs | V2X | Public Safety | IIoT | Commercial |
| Horizontal | Set A (similar to “Set 2” | 1 m for 90% of | Set A: 1 m | 1 m for 90% of UEs |
| Positioning | defined in [2]): | UEs (absolute or | for 90% of | (absolute or relative) |
| Accuracy | 1.5 m for 90% of UEs | relative) | UEs (absolute | |
| | (absolute or relative) | | or relative) | |
| | Set B (similar to “Set 3” | | Set B: 0.2 m | |
| | defined in [2]): | | for 90% of | |
| | 0.5 m for 90% of UEs | | UEs (absolute | |
| | (absolute or relative) | | or relative) | |
| Vertical | Set A: 3 m for 90% of UEs | 2 m (absolute or | Set A: 1 m | 2 m for 90% of UEs |
| Positioning | (absolute or relative) | relative between | for 90% of | (absolute or relative) |
| Accuracy | | 2 UEs) for 90% | UEs (absolute | |
| | | of UEs | or relative) | |
| | Set B: 2 m for 90% of UEs | 0.3 m (relative | Set B: 0.2 m | |
| | (absolute or relative) | positioning | for 90% of | |
| | | change for 1 UE) | UEs (absolute | |
| | | for 90% of UEs | or relative) | |
| Relative | — | Up to 30 km/h | Up to 30 km/h | Up to 30 km/h |
| Speed | | | | |

| | |
|---|---|
| Angle | Set A: Y = ±15° for 90% of the UEs |
| Accuracy | Set B: Y = ±8° for 90% of the UEs |

NOTE 1:
Target positioning requirements may not necessarily be reached for all scenarios and deployments
NOTE 2:
All positioning techniques may not achieve all positioning requirements in all scenarios.

The supported positioning techniques in Release 16 are listed in Table T2.

TABLE T2
Supported Rel-16 UE Positioning Methods

| | | | NG-RAN | |
|---|---|---|---|---|
| | UE- | UE-assisted, | node | |
| Method | based | LMF-based | assisted | SUPL |
| A-GNSS | Yes | Yes | No | Yes |
| | | | | (UE-based and |
| | | | | UE-assisted) |
| OTDOA ^{Notes1, 2} | No | Yes | No | Yes |
| | | | | (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes |
| | | | | (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}
This includes TBS positioning based on PRS signals.
^{NOTE 2}
In this version of the specification only observed time different of arrival (OTDOA) based on LTE signals is supported.
^{NOTE 4}
This includes Cell-ID for NR method.
^{NOTE 5}
In this version of the specification only for TBS positioning based on Metropolitan Beacon System (MBS) signals.

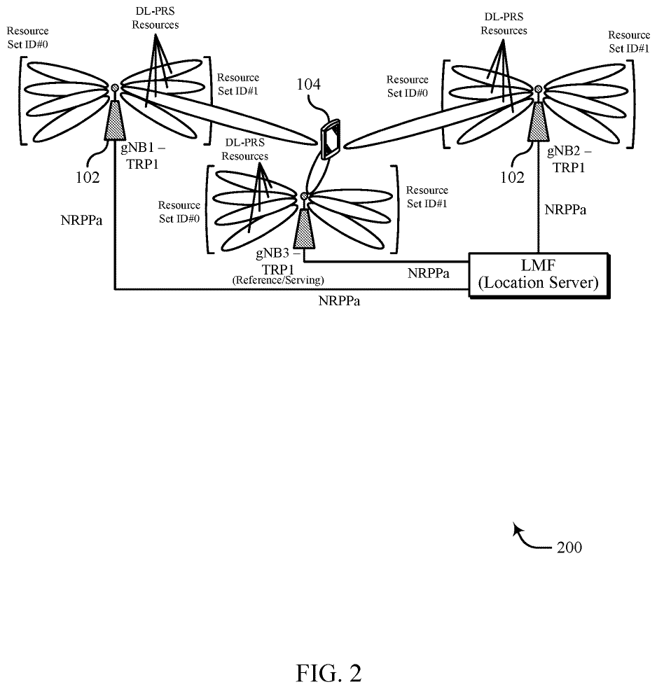

Separate positioning techniques as indicated in Table T2 can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of a system 200 for NR beam-based positioning as related to carrier phase positioning configuration in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as reference signal time difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location.

Tables T3 and T4 show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, wireless local area network (WLAN), and Bluetooth technologies for performing target device (UE) positioning.

TABLE T3
UE measurements to enable RAT-
dependent positioning techniques.

| | | To facilitate |
|---|---|---|
| | | support of the |
| DL/UL Reference | | positioning |
| Signals | UE Measurements | techniques |
| Rel.16 DL PRS | DL RSTD | DL-TDOA |
| Rel.16 DL PRS | DL PRS RSRP | DL-TDOA, |
| | | DL-AOD, |
| | | Multi-RTT |
| Rel.16 DL PRS / Rel.16 | UE Rx − Tx time difference | Multi-RTT |
| SRS for positioning | | |
| Rel. 15 SSB / channel | SS-RSRP(RSRP for RRM), | NR E-CID |
| state information (CSI) | SS-RSRQ(for RRM), | |
| reference signal (RS) | CSI-RSRP (for RRM), | |
| (CSI-RS) for radio | CSI-RSRQ (for RRM), | |
| resource management | SS-RSRPB (for RRM) | |
| (RRM) | | |

TABLE T4
gNB measurements to enable RAT-dependent
positioning techniques.

| | | To facilitate |
|---|---|---|
| | | support of the |
| DL/UL Reference | | positioning |
| Signals | gNB Measurements | techniques |
| Rel.16 SRS for | UL RTOA | UL-TDOA |
| positioning | | |
| Rel.16 SRS for | UL SRS-REFERENCE | UL-TDOA, |
| positioning | SIGNAL RECEIVED | UL-AoA, |
| | POWER (RSRP) | Multi-RTT |
| Rel.16 SRS for | gNB Rx − Tx time | Multi-RTT |
| positioning, Rel.16 | difference | |
| DL PRS | | |
| Rel.16 SRS for | AoA and ZoA | UL-AoA, |
| positioning | | Multi-RTT |

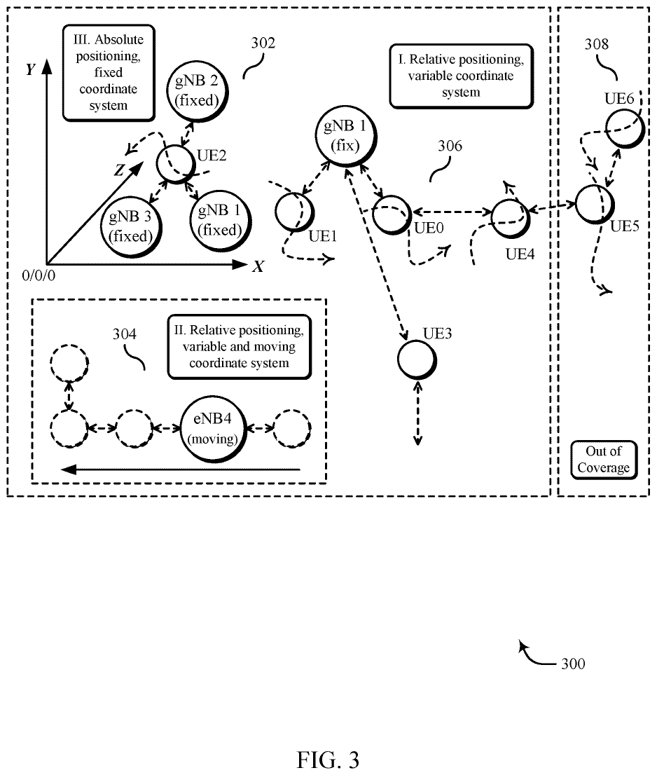

FIG. 3 illustrates an example 300 of absolute and relative positioning scenarios as related to carrier phase positioning configuration in accordance with aspects of the present disclosure. The network devices described with reference to example 300 may use and/or be implemented with the wireless communications system 100 and include UEs 104 and network entities 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDoA, DL-AoD, Multi-RTT, enhanced cell-ID (E-CID)/NR E-CID, UL-TDoA, and UL-AoA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs. The Multi-RTT positioning method makes use of the UE Rx-Tx measurements and DL PRS RSRP of downlink signals received from multiple TRPs, measured by the UE and the measured gNB Rx-Tx measurements and uplink (UL) sounding reference signal (SRS) reference signal receive power (RSRP) at multiple TRPs of uplink signals transmitted from UE.

FIG. 4 illustrates an example 400 of a multi-cell RTT procedure as related to carrier phase positioning configuration in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink SRS RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table T1.

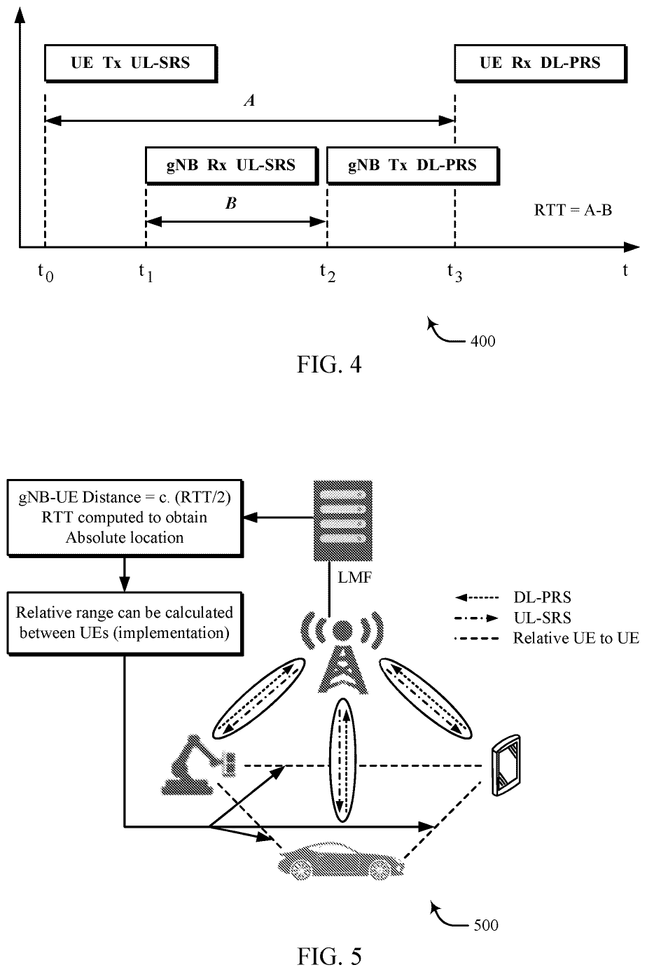

FIG. 5 illustrates an example of a system 500 for relative range estimation using a gNB RTT positioning framework as related to carrier phase positioning configuration in accordance with aspects of the present disclosure. The system 500 illustrates the relative range estimation using the existing single gNB RTT positioning framework. The location server (e.g., LMF) can configure measurements to the different UEs, and then the target UEs can report their measurements in a transparent way to the location server. The location server can compute the relative distance between two UEs. This approach is high in latency and is not an efficient method in terms of procedures and signaling overhead.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different downlink measurements used for RAT-dependent positioning techniques include including DL PRS-RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing; 8 DL PRS RSRP measurements can be performed on different DL PRS resources from the same cell.

The DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

The DL RSTD is the downlink relative timing difference between the positioning node j and the reference positioning node i, defined as T_{SubframeRxj}−T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. The DL RSTD is applicable for RRC_CONNECTED intra-frequency and RRC_CONNECTED inter-frequency.

The UE receive-transmit (Rx-Tx) time difference is defined as T_{UE-RX}−T_{UE-TX}, where T_{UE-RX} is the UE received timing of downlink subframe #i from a positioning node, defined by the first detected path in time, and T_{UE-TX} is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE. The UE Rx-Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

TABLE T5
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay |
| | of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED |
| | RRC_INACTIVE |

The following are some non-limiting examples of entities and terminologies that may be utilized in this disclosure.
Initiator device can initiate a sidelink positioning/ranging session, and may be implemented as a network entity (e.g., gNB, LMF, etc.) a UE, a roadside unit (RSU), etc.
Responder device can respond to a SL positioning/ranging session from an initiator device, and may be implemented as a network entity (e.g., gNB, LMF), a UE, a roadside unit (RSU), etc.
Target UE can represent a UE of interest a position of which (e.g., absolute and/or relative) is to be obtained by an entity such as a network, another UE, and/or by the target UE itself.
Sidelink positioning: Positioning UE using reference signals transmitted over sidelink (e.g., PC5 interface) to obtain absolute position, relative position, ranging information, etc.
Ranging: Determination of a distance and/or direction between a UE and another entity, e.g., anchor UE.
Anchor UE: A UE supporting positioning of a target UE, e.g., by transmitting and/or receiving reference signals for positioning, providing positioning-related information, etc., over the sidelink interface. An anchor UE may additionally or alternatively be referred to as sidelink reference UE, a reference UE, etc.
Assistant UE: A UE supporting ranging/sidelink between a sidelink reference UE and target UE over PC5, such as in scenarios where direct ranging/sidelink positioning between the sidelink reference UE/anchor UE and the target UE may not be supported. Measurement results of ranging/sidelink positioning between the assistance UE and the sidelink reference UE, and that between the assistance UE and the target UE can be determined and used to derive the ranging/sidelink positioning results between target UE and sidelink reference UE.
Sidelink Positioning Server UE: A UE enabling location calculation for sidelink positioning and ranging-based service. The sidelink positioning server UE can interact with other UE over PC5 to calculate the location of a target UE. A target UE and/or sidelink reference UE can act as sidelink positioning server UE.
Sidelink Positioning Client UE: A third-party UE (e.g., other than sidelink reference UE and/or the target UE) which can initiate a ranging/sidelink positioning service request on behalf of an application residing on the sidelink positioning client UE. In implementations a sidelink positioning client UE does not have to support ranging/sidelink positioning capability but a communication between the sidelink positioning client UE and a sidelink reference UE/target UE may be established (e.g., via PC5, 5GC, etc.) for transmission of a service request and a positioning result.
Sidelink positioning node may refer to a network entity and/or device/UE participating in a sidelink positioning session, e.g., LMF (location server), gNB, UE, RSU, anchor UE, initiator UE, responder UE, etc.
Configuration entity: A network node and/or other device/UE capable of configuring time-frequency resources and related sidelink positioning configurations. A sidelink positioning server UE may serve as a configuration entity.

In at least some implementations, techniques for enabling aggregated positioning measurements are described, including TDOA-like methods and RTT variants, as well as reporting content and associated positioning measurement metric information. Implementations support measurement configuration and associated reporting of aggregated PRS measurements, as well as measurements based on and/or derived from frequency hopping. Aggregated SL PRS measurements can be performed, including RSTD, RTOA, and UE Rx-Tx time difference measurements based on certain conditions that depend on the SL-PRS configuration of each positioning frequency layer (PFL) or carrier.

One or more of the implementations are supported via appropriate UE capability indication signaling to a configuration device and/or UE, and implementations may be combined with each other to support NR RAT-dependent positioning methods over the SL (PC5) interface. As used herein, a positioning-related reference signal may be referred to as a reference signal used for positioning procedures or purposes in order to estimate a target-UE's location, such as a PRS, or based on existing reference signals such as channel state information reference signal (CSI-RS) or SRS. A target-UE may be referred to as the device or entity to be localized and/or positioned. In various implementations, the term PRS may refer to any signal, such as a reference signal, which may or may not be used primarily for positioning. Additionally, any reference made to position and/or location information may refer to an absolute position or a relative position with respect to another node or entity, ranging in terms of distance, ranging in terms of direction, or combination thereof.

With reference to configuration and reporting, the configuration device or UE can configure a measurement UE or receiving device to report aggregated measurements according to the positioning measurement type. The positioning measurement type can include RSTD, RTOA, multi-UE or device RTT, one-sided SL-RTT, double-sided RTT, and multi-RTT. The applicability may extend to sidelink (SL), downlink (DL), and uplink (UL) positioning measurements. In another implementation, the positioning measurements may also include AoA, RSRP, RSRPP, and AOD, the applicability of which may also extend to sidelink, downlink, and uplink positioning measurements.

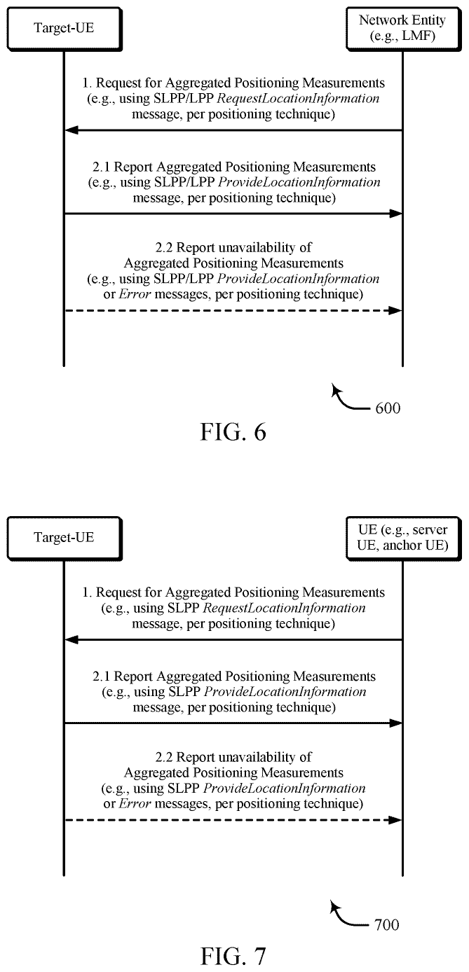

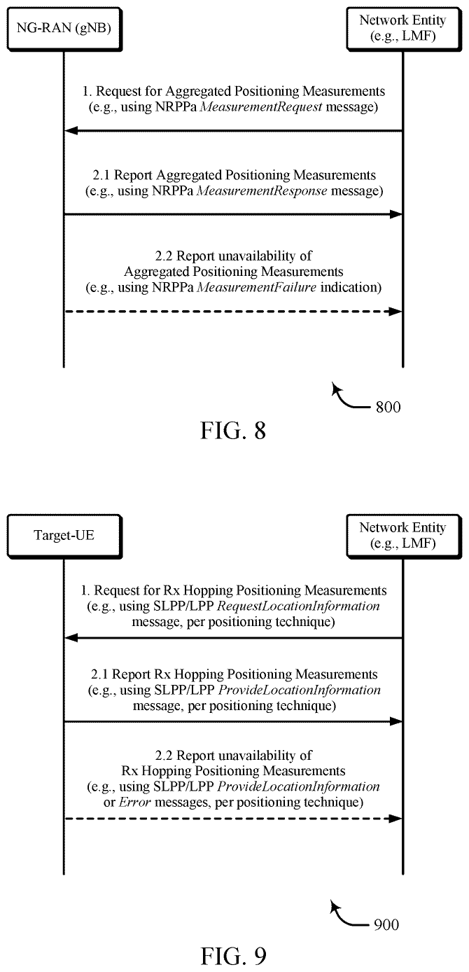

FIGS. 6, 7, and 8 illustrate procedures to perform measurement configuration and reporting based on aggregated positioning measurements, as related to aggregated positioning measurements and reporting in accordance with aspects of the present disclosure. FIG. 6 illustrates a procedure 600 including a network entity requests aggregated positioning measurements and a target UE (e.g., a measurement UE or device) provides the aggregated positioning measurement report. FIG. 7 illustrates a procedure 700 including a UE requests aggregated positioning measurements and a target UE provides the associated aggregated positioning measurement report. FIG. 8 illustrates a procedure 800 including a network requests aggregated positioning measurements and another network entity (e.g., a gNB as the measurement device) provides the associated aggregated positioning measurement report.

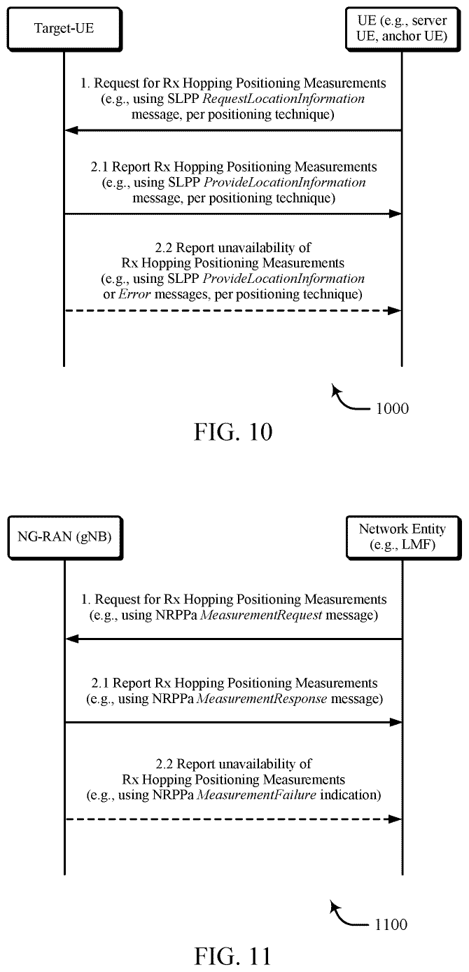

FIGS. 9, 10, and 11 illustrate procedures to perform measurement configuration and reporting based on SL-PRS aggregated positioning measurements, as related to aggregated positioning measurements and reporting in accordance with aspects of the present disclosure. In one or more implementations, a configuration device (e.g., a UE) can configure a measurement UE and/or receiving device to report Rx frequency hopping measurements according to the positioning measurement type. FIG. 9 illustrates a procedure 900 including a network entity requests Rx hopping positioning measurements and a target UE provides the positioning measurement report associated with Rx hopping per positioning technique. FIG. 10 illustrates a procedure 1000 including a UE requests Rx hopping positioning measurements and a target UE provides the positioning measurement report associated with Rx hopping per positioning technique. FIG. 11 illustrates a procedure 1100 including a network requests Rx hopping positioning measurements and another network entity (e.g., a gNB) provides the associated Rx hopping per positioning technique.

In one or more implementations, the UE or gNB reports the identifiers related to which positioning frequency layer or carrier that was measured in order to derive an aggregated positioning measurement. The positioning measurement device (e.g., a UE or gNB) can be configured to report indications of the aggregated DL, UL, or SL carriers containing a positioning reference signal, including a single aggregation ID, which links to all PFLs or carriers which were aggregated, or individual PFL IDs or carrier IDs associated with an aggregated measurement.

In one or more implementations, the measurement device is configured to report line of sight (LOS) and/or non-LOS (NLOS) indications of the individual carriers transmitting the positioning reference signal prior to aggregation, or an average or weighted LOS and/or NLOS indication of the aggregated positioning measurements. The measurement device (e.g., UE or gNB) can report the LOS and/or NLOS indication of an aggregated positioning measurement.

In an additional implementation, a configuration device (e.g., a UE or location server) can configure the measurement device, UE, and/or gNB to perform aggregated or Rx hopping measurements based on a measurement window, which may be configured in advance. The measurement window can be characterized or identified by a start time, periodicity, and/or an end time in varying time formats, including coordinated universal time (UTC) time, GNSS time, network time (e.g., system frame number (SFN)/DFN, E-UTRA time, or relative time).

In another implementation, the error or impairments associated with a particular aggregated measurement may be reported based on a received measurement configuration. In the case of timing-based positioning methods, aggregated measurements may be based on Tx or Rx timing error groups (TEG) associated to an aggregated positioning measurement. These timing error groups may be associated with same IDs across different PFLs/carriers. In another implementation, if the TEG exceeds a certain a threshold, different TEGs may have to be reported associated each PFL/carrier used to derive the aggregated positioning measurement.

In an additional implementation, the aggregated PRS measurements or Rx PRS hopping measurements can be configured to a PRU UE for the purposes of enhanced positioning error mitigation. This may apply to both DL-based and SL-based positioning measurements. The support may also extend to carrier phase positioning measurements, including reference signal carrier phase (RSCP), reference signal carrier phase difference (RSCPD), and subcarrier phase differential measurements. The PRU UE may also be configured to simultaneously perform aggregated positioning measurement or Rx frequency hopping of positioning measurements based on the described positioning measurement configured to both PRU UE and target-UE.

In another implementation for SL positioning, the aggregated measurements or Rx frequency positioning measurements can be reported along with SL-PRS resource granularities used to derive the measurement, including carrier IDs, BWP IDs, resource pool IDs, resource set IDs, and resource IDs. In another implementation, the aggregated measurements can be associated with timestamp information, indicating the time at which the aggregated measurements or Rx frequency hopping measurements were performed.

With reference to aggregated positioning measurements, a configuration device or UE can configure a measurement UE and/or receiving device to report aggregated measurements according to certain conditions. The positioning measurement types may include SL RSTD, SL RTOA, multi-UE or device SL RTT, and/or UE Rx-Tx time difference measurement. In another implementation, the positioning measurements may also include sidelink angle of arrival (SL-AOA), sidelink reference signal receive power (SL-RSRP), sidelink reference signal received path power (SL-RSRPP), and/or sidelink angle of departure (SL-AOD).

The SL RSTD is the measured time difference in the time-of-arrival (TOA) of SL-PRS between a pair of transmission points (TPs), including a reference transmission point (TP) and a normal TP. The transmission points can originate from a UE (e.g., RSU, anchor UE, etc.). In order to aggregate the SL RSTD measurement, the conditions are satisfied in one or more implementations. The conditions can include the multiple SL PRS resources from multiple carriers used to determine the start subframe or slot time, and the carriers may be intra-band contiguous carriers, intra-band non-contiguous carriers, or inter-band carriers. The conditions can also include the start subframe or slot time is time aligned across multiple carriers in order to jointly process the SL RSTD measurement. The conditions can also include a SL-PRS transmitted and received SL-PRS across different carriers to derive the SL RSTD measurement originating from a single Tx and Rx chain, respectively. In another sub-implementation, the SL-PRS may be aggregated across multiple pairs of Tx and Rx chain, albeit with an increase in complexity of the aggregated SL RSTD measurement.

The SL RTOA is the measurement time-of-arrival (TOA) relative to the RTOA reference time at a plurality of reception points (RPs). The RPs can originate from a UE (e.g., RSU, anchor UE, etc.). In order to aggregate the SL RTOA measurement, conditions are to be satisfied in one or more implementations. The conditions can include that multiple SL PRS resources from multiple carriers are used to determine the start subframe or slot time, and the carriers may be intra-band contiguous carriers, intra-band non-contiguous carriers, or inter-band carriers. The conditions can also include the reference time is aligned or the same across multiple SL carriers (i.e. based on SFN0/SFN or DFN0/DFN). The conditions can also include the start subframe or slot time is time aligned across multiple carriers in order to jointly process the SL RTOA measurement. The conditions can also include the SL-PRS transmitted and received SL-PRS across different carriers to derive the SL RTOA measurement originating from a single Tx and Rx chain, respectively. In another sub-implementation, SL-PRS may be aggregated across multiple pairs of Tx and Rx chain, albeit with an increase in complexity of the aggregated SL RTOA measurement.

The SL UE Rx-Tx time difference measurement is the defined by the time difference between the reception time of the first detected path of the SL-PRS and the transmission time of the SL-PRS. The transmission time of the SL-PRS may be associated with the actual time of SL-PRS, which is linked to the received SL-PRS, or is the subframe closest in time to the received subframe of the SL-PRS. In order to aggregate the SL UE Rx-Tx time difference measurement, conditions are to be satisfied in one or more implementations. The conditions can include that multiple SL PRS resources from multiple carriers are used to determine the start actual time, subframe, or slot time, and the carriers may be intra-band contiguous carriers, intra-band non-contiguous carriers, or inter-band carriers. The conditions can also include the start actual time, subframe, or slot time is time aligned across multiple carriers in order to jointly process the SL RTOA measurement. The conditions can also include the SL-PRS transmitted and received SL-PRS across different carriers to derive the SL UE Rx-Tx time difference measurement originates from a single Tx and Rx chain, respectively. In another sub-implementation, SL-PRS may be aggregated across multiple pairs of Tx and Rx chain, albeit with an increase in complexity of the aggregated SL RTOA measurement.

The SL RSRP is defined as the linear average over the power contributions (in W) of the resource elements that carry SL PRS reference signals configured for RSRP measurements within the considered measurement frequency bandwidth. According to an aspect of the implementation, the considered measurement frequency bandwidth may extend across multiple carriers, bandwidth parts (BWPs), resource pools, resource sets, and/or resources associated to the SL PRS RSRP measurement.

The SL RSRPP is defined as the power of the linear average of the channel response at the i-th path delay of the resource elements that carry the SL PRS signal configured for the measurement, where SL PRS-RSRPP for the first path delay is the power contribution corresponding to the first detected path in time. According to an aspect of the implementation, the considered measurement frequency bandwidth may extend across multiple carriers, BWPs, resource pools, resource sets, and/or resources associated to the SL PRS-RSRP measurement.

In order to aggregate the SL PRS RSRP or SL PRS RSRPP measurements, conditions are to be satisfied in one or more implementations. The conditions can include multiple SL PRS resources used to determine the linear average of the power contributions (in W) of each of the REs, or the linear average of the channel response at the i-th path from each of the configured multiple carriers. Further, the carriers may be intra-band contiguous carriers, intra-band non-contiguous carriers, or inter-band carriers. In the case of the SL PRS RSRP, the first path from the SL PRS from each of the carriers are used to derive the aggregated SL PRS RSRP measurement. In the case of the SL PRS RSRPP, the i-th path of the channel response from the SL PRS from each of the carriers are aligned and are used to derive the aggregated SL PRS RSRPP measurement. In another implementation, the conditions may be extended to downlink-based positioning measurements, such as downlink RSTD, UE Rx-Tx time difference measurement, DL PRS, PRS RSRP, PRS RSRPP, or UL-based positioning measurements, including UL-AOA, UL-RTOA, gNB Rx-Tx time difference measurements, or UL SRS RSRP or UL SRS RSRPP.

With reference to capability indication, the UE capability signaling to support PRS bandwidth measurement aggregation and processing, or PRS/SRS Tx/Rx frequency hopping, can be included. The applicability of such UE capability signaling applies to SL-PRS, DL-PRS, and/or SRS for positioning. According to an aspect of the implementation, the UE capabilities for PRS aggregation and PRS/SRS Tx/Rx frequency hopping may be requested by a third network entity, such as LMF, NG-RAN, gNB, or UE (e.g., server UE or client UE based on a solicited request).

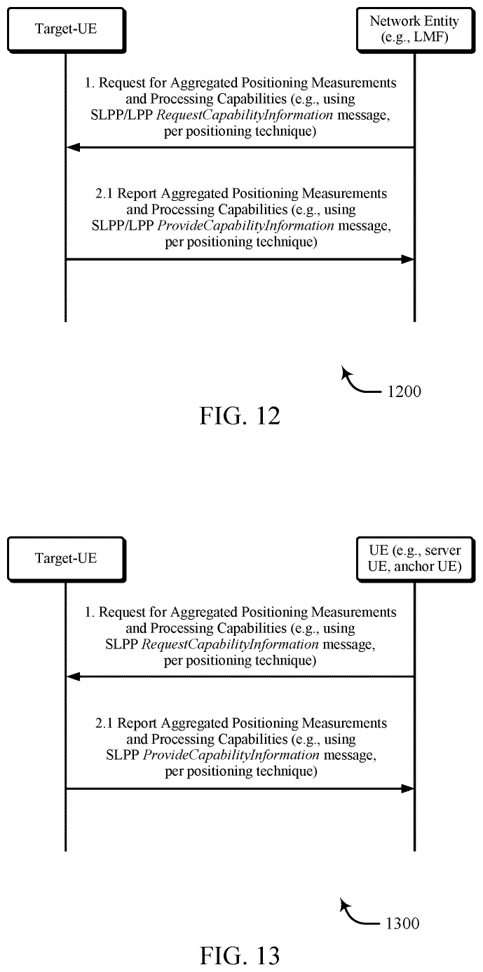

FIGS. 12 and 13 illustrate procedures for request and response signaling for aggregated positioning measurement and processing, as related to aggregated positioning measurements and reporting in accordance with aspects of the present disclosure. The processing and measurement capabilities for performing aggregated measurements may be configured based on the supported positioning techniques. FIG. 12 illustrates an example 1200 including the LTE positioning protocol (LPP) signaling used to determine the aggregated positioning measurement and processing capabilities for Uu positioning, while in other implementations, sidelink positioning protocol (SLPP) capabilities may be transported as a container within LPP or as a separate SLPP message to the LMF. FIG. 13 illustrates an example 1300 including SLPP used to exchange capability messages between involved UEs for performing enhanced SL positioning based on aggregated positioning measurements.

According to an aspect of this implementation, processing capabilities include the ability to jointly process PRS across multiple PFLs, carriers, BWPs, resource pools, resource sets, and/or resource IDs. In addition, the different UEs may support multiple combinations of carriers with a maximum configured limit based on deployment as well as different combinations of bandwidths per carrier. This can be specified in terms of bandwidth combination sets as shown in the following Table of Bandwidth Combination Sets.

| | PFL/Carrier | PFL/Carrier | PFL/Carrier | PFL/Carrier |
|---|---|---|---|---|
| | Bandwidth | Bandwidth | Bandwidth | Bandwidth |
| UE capability | 1 (MHz) | 2 (MHz) | 3 (MHz) | N (MHz) |
| Bandwidth | 20 | 40 | 100 | N1 |
| Combination | | | | |
| Set 1 | | | | |
| Bandwidth | 20 | 20 | 20 | N2 |
| Combination | | | | |
| Set 2 | | | | |
| Bandwidth | 40 | 40 | 40 | N3 |
| Combination | | | | |
| Set 3 | | | | |
| Bandwidth | M1 | M2 | M3 | NM |
| Combination | | | | |
| Set M | | | | |

In an implementation, the bandwidth combination sets may be expressed in terms of PRBs or sub-channels, or a combination thereof. A separate UE capability can be specified based on supported resource pool bandwidths for dedicated resource pools for positioning and/or shared resource pools of SL-PRS and SL data. In an implementation, the capabilities of aggregated bandwidth for PRS/SRS can extend to DL PRS, UL SRS and SL-PRS, where an N number of PRS symbols are processed every T ms over an aggregated bandwidth of B in MHz. These values of N and T are reported based on the aggregated SL-PRS across multiple carriers, BWPs, resource pools, resource sets, and/or resources, while in other implementations, these values of N and T will be reported for DL-PRS aggregated across multiple PFLs. In another implementation, the same signaling framework shown in FIGS. 12 and 13 may be used to exchange capability information related to Rx PRS hopping, including the maximum number of supported hops, hopping interval (consecutive or non-consecutive) (e.g., on slot-level, subframe-level, in ms, bandwidth across hops, hoping patterns, or a combination thereof).

As described herein, and in the context of SL positioning, a variety of SL positioning techniques can be utilized to enhance SL positioning performance (e.g., in terms of better accuracy and/or low latency positioning). However, for certain spectrum deployments (e.g., V2X), the available bandwidths may be limited and thus techniques can be implemented in order make the best use of the available spectrum to maximize positioning performance gains (e.g., accuracy in terms of enabling SL-PRS bandwidth aggregation and SL-PRS Tx/Rx frequency hopping). The measurement configuration and reporting procedural details, as well as the conditions for supporting PRS bandwidth aggregation, are described herein, which may be applicable to different PRS (e.g., SL-PRS, DL-PRS, etc.).

Further, solutions are provided in this disclosure for enabling SL-PRS aggregation and frequency hopping in order to enhance SL positioning accuracy and support SL Positioning in limited bandwidths. For instance, implementations are described that detail transmission characteristics and scenarios in which SL-PRS may be aggregated as well as scenarios to support SL-PRS frequency hopping. Further, implementations provide configuration parameters to configure a receiving/measurement UE to perform SL-PRS aggregation and/or frequency hopping, such as in scenarios involving limited bandwidth. Still further, implementations enable the described SL-PRS bandwidth aggregation and frequency hopping features via activation and/or deactivation (e.g., release) signaling indications.

The implementations described herein may be implemented in combination to support NR RAT-dependent positioning methods over the SL (PC5) interface. Further, for purposes of this disclosure, a positioning-related reference signal may be referred to as a reference signal used for positioning procedures and/or purposes to estimate a target UE location, such as PRS and/or based on existing reference signals such as CSI-RS, SRS, etc. Further, a target-UE may be referred to as a device and/or entity to be localized and/or positioned. In various implementations the term ‘PRS’ may refer to any signal such as a reference signal which may or may not be used primarily for positioning. For purposes of this disclosure any reference made to position and/or location information may refer to an absolute position, relative position with respect to another node and/or entity, ranging in terms of distance, ranging in terms of direction, or combinations thereof.

In implementations, aggregated SL-PRS transmission characteristics are described in order to enable SL carrier types to be aggregated for enhancing overall positioning accuracy. Further, implementations also cover scenarios where different resource pools from a same carrier (e.g., sidelink) may be aggregated. An aggregated bandwidth from different carriers and/or resource pools may increase the time resolution of different received path components and thus increase overall timing estimation accuracy.

In implementations one or more conditions to be satisfied for SL-PRS aggregation across different SL carriers include:
SL-PRS having a same periodicity.
SL-PRS having a same slot offset, e.g., DFN0 or SFN0.
SL-PRS having a same comb-size, e.g., either a fully staggered pattern M=N, M>N, or a partially staggered pattern M<N, where M is the length of the symbols of SL-PRS in a slot, while N is comb-size defined in frequency domain.
SL-PRS having a same muting pattern.
SL-PRS transmitted from a same antenna port.
SL-PRS sharing a same antenna reference point identifier (ARP ID)/panel ID.
SL-PRS resources with a same or different number of dedicated resource pools within a carrier. In implementations shared resource pools may be considered to be aggregated provided that SL-PRS is transmitted along with sidelink communication data.
Using a single Tx/Rx RF chain.

In implementations a sidelink dedicated resource pool can represent a set of time-frequency resources used to solely perform positioning, while a shared resource pool can represent a set of time-frequency resources used for both positioning and data purposes. Further, the above conditions can be mutually exclusive, which can allow satisfaction of at least one of the conditions to perform SL-PRS bandwidth aggregation.

In implementations, a subset of features may overlap in order to perform SL-PRS aggregation. For example, if a SL-PRS resource has a periodicity of 4 ms in one carrier and a periodicity of 2 ms in another carrier, the overlapping portions of the SL-PRS resource in the time domain may be aggregated. In implementations, SL-PRS resources with different features across carriers may be aggregated.

In implementations, SL-PRS resources may be aggregated within a carrier. In such scenarios, multiple resource pools within a single SL carrier may be aggregated. Further, the aggregation may occur across different SL BWPs. One or more conditions to be at least satisfied for SL-PRS aggregation across different SL BWP may include:
SL-PRS belonging to dedicated (positioning) pools.
SL-PRS belonging to shared resource pools.
BWP switching time can be minimized, e.g., based on a BWP switching time threshold and/or a specified BWP switching time.
SL-PRS belonging to dedicated and shared resource pools subject to the SL-PRS configuration being aligned across the dedicated and shared resource pools, such as based on one or more of the following conditions:
   SL-PRS in a dedicated resource pool are not to be aggregated with overlapping physical sidelink shared channel (PSSCH) symbols in the shared pool, e.g., SL-PRS symbols in the dedicated pool can only be aggregated with overlapping SL-PRS symbols in the shared pool.
   SL-PRS having a same slot offset, e.g., DFN0 or SFN0.
   SL-PRS having the same comb-size, e.g., either fully staggered pattern M=N, M>N, or partially staggered pattern M<N, where M is the length of the symbols of SL-PRS in a slot, while N is comb-size such as defined in frequency domain.
   SL-PRS having a same muting pattern.
   SL-PRS transmitted from a same antenna port.
   SL-PRS sharing a same ARP ID and/or panel ID.
   SL-PRS with a same or different number with dedicated and shared resource pools within a BWP. In implementations shared resource pools may be considered to be aggregated provided that SL-PRS is transmitted along with sidelink communication data.

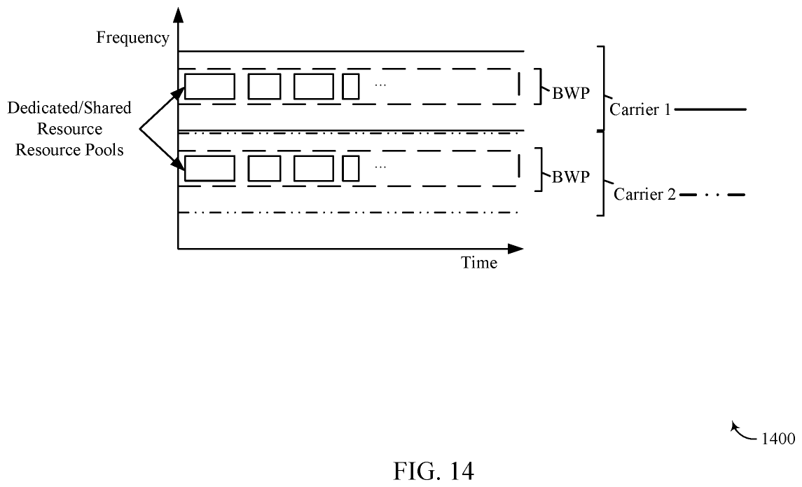

FIG. 14 illustrates a scenario 1400 that supports sidelink positioning using bandwidth aggregation in accordance with aspects of the present disclosure. In the scenario 1400, for instance, SL-PRS aggregation in the intra-band contiguous carrier case can be based on the above-described scenarios.

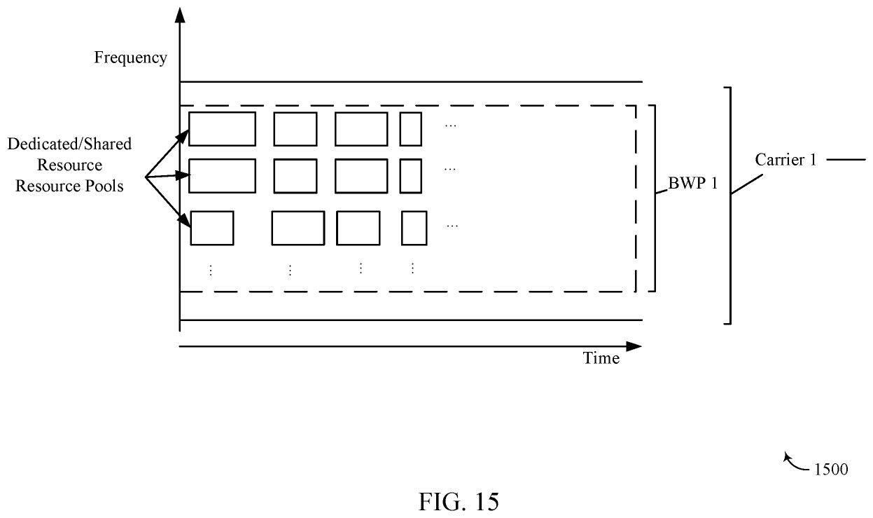

FIG. 15 illustrates a scenario 1500 that supports sidelink positioning using bandwidth aggregation in accordance with aspects of the present disclosure. The scenario 1500, for instance, illustrates SL-PRS aggregation within a single carrier, which can involve the aggregation of resource pools within a single BWP.

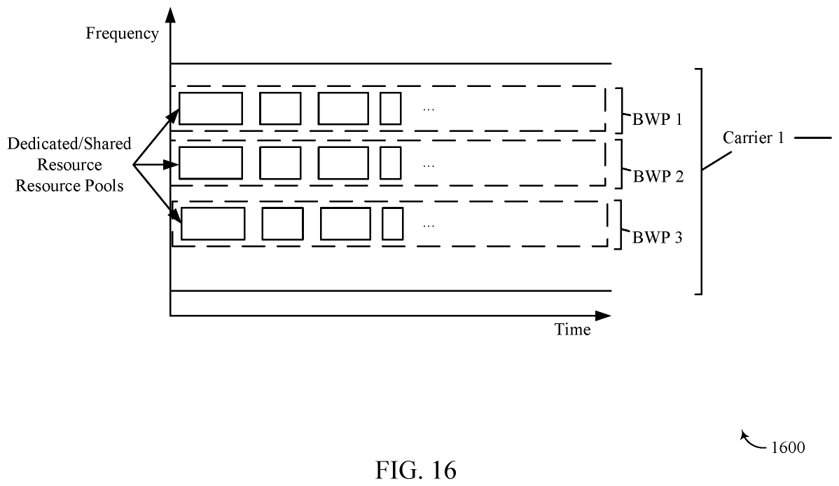

FIG. 16 illustrates a scenario 1600 that supports sidelink positioning using bandwidth aggregation in accordance with aspects of the present disclosure. The scenario 1600, for instance, illustrates aggregation of SL-PRS across multiple sidelink BWP within a single carrier. In implementations the above SL-PRS transmission characteristics may be applicable for intra-band non-contiguous carriers and inter-band carriers.

In implementations, one or more of the scenarios 1400, 1500, 1600 may be implemented in one or more combinations to achieve SL-PRS aggregation. In implementations and in one or more of the scenarios 1400, 1500, 1600, the resource pools may be partially overlapping or completely overlapped in addition to the non-overlapping scenarios such as illustrated in the corresponding figures.

In extensions and/or variations of the scenario 1600, a receiving UE may receive, measure, and process SL-PRS as function of multiple hops to perform Rx hopping of SL-PRS. In such implementations the SL-PRS bandwidth can be assumed to be the same as the resource pool bandwidth with resource pools, which may or may not overlap in the time domain. The receiving UE may process the SL-PRS based on a received hopping pattern within a SL-PRS configuration, which may be signaled via LPP, sidelink control information (SCI), MAC CE, PC5 RRC SLPP, or combinations thereof. In an extended implementation, the Rx hopping may be up to UE implementation.

According to implementations SL-PRS receive hopping may be configured to be measured for sidelink positioning measurements. For instance, the receive frequency hopping may be performed across TRP, BWP, resource pools, resource sets, and/or resources. Further, the frequency hopping may be performed across overlapping and non-overlapping frequency resources, e.g., PRBs, sub-channels, etc. Further configuration details associated with SL-PRS receive hopping may include time gap between consecutive or non-consecutive hops (e.g., slot-level), symbol-level granularities, number of hops, start PRB and/or start sub-channel of hops, etc.

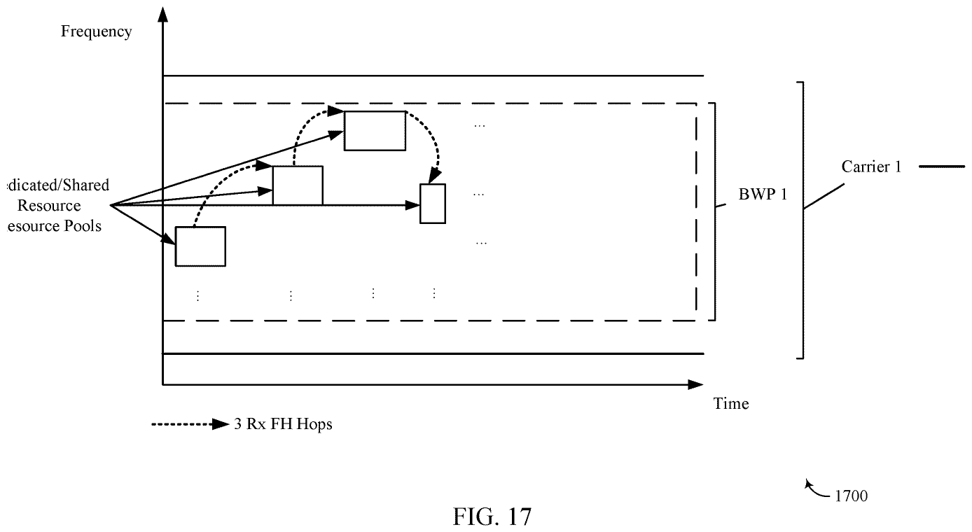

FIG. 17 illustrates a scenario 1700 that supports sidelink positioning using bandwidth aggregation in accordance with aspects of the present disclosure. The scenario 1700, for instance, illustrates performing three SL-PRS receive frequency hops within a single BWP to perform a SL positioning measurement. In implementations the last resource pool may overlap in frequency with the second resource pool.

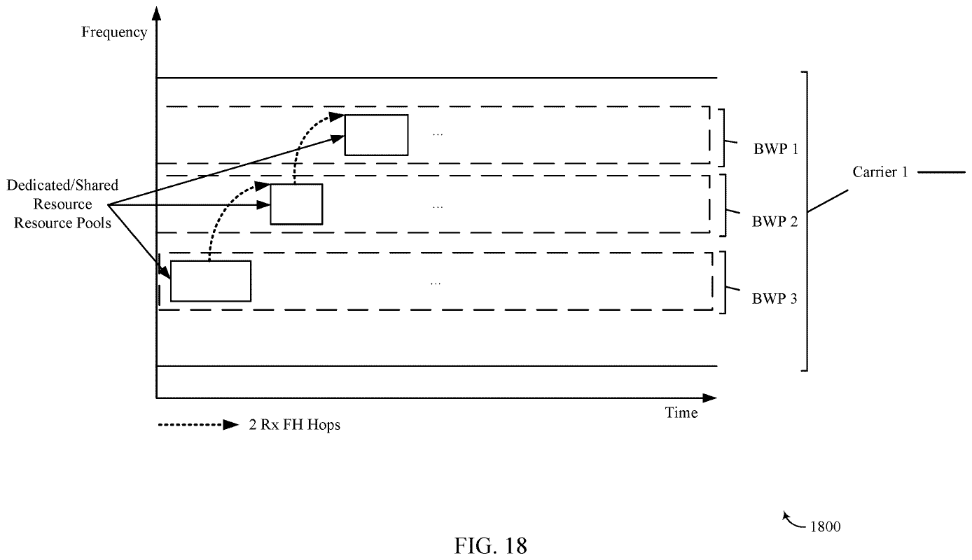

FIG. 18 illustrates a scenario 1800 that supports sidelink positioning using bandwidth aggregation in accordance with aspects of the present disclosure. The scenario 1800, for instance, illustrates performing two SL-PRS receive frequency hops across different BWP with different resource pools containing SL-PRS.

In implementations of sidelink positioning using bandwidth aggregation a configuration device may receive a trigger to perform SL-PRS bandwidth aggregation. In at least one implementation the trigger may be triggered by higher layers and/or higher layer signaling within a same configuration device, e.g., application layer, V2X layer, ProSe layer, SLPP layer, PC5 RRC layer, or combinations thereof.

In implementations a higher layer signaling, e.g., application layer, V2X layer, ProSe layer, SLPP layer, PC5 RRC layer, and/or lower layer signaling, e.g., SCI, downlink control information (DCI), MAC CE trigger from another entity (e.g., device UE, network entity, etc.) may be used to trigger a procedure to perform SL-PRS bandwidth aggregation. The entity may include a location server, gNB, anchor UE, target UE, server UE, in part and/or any combination thereof.

A SL-PRS bandwidth aggregation configuration may be indicated to a receiving device/UE and/or measurement device/UE in terms of a resource hierarchy such as based on the scenario and/or UE capabilities. One or more following resource hierarchies may be signaled to the receiving device/UE in order to perform aggregated measurements:
Positioning Frequency Layer (PFL)
Carrier
BWP
Transmission Reception Point
Resource Set
Resource

The above resource hierarchical features may be associated with an ID that enables the receiving device/UE to concatenate and/or aggregate different SL-PRS resources such as based on a link and/or relationship in time and frequency. The resource hierarchical features described above may be applied to SL, Uu including uplink and/or downlink, and combinations thereof.

In implementations SL-PRS resources may be aggregated on multiple levels such as depending on complexity and flexibility considerations. The configured SL-PRS resources may be aggregated across all SL-PRS resources present in a carrier and/or PFL, while in other implementations the SL-PRS resources may be aggregated on SL-PRS resource level, which can enable a maximum granularity and flexibility on which resources within a resource set, resource pool, and/or BWP may be aggregated. From a network perspective, such a configuration can allow configuration of SL-PRS for UE performing SL-PRS aggregation and UE not performing SL-PRS aggregation.

In implementations the availability of time-frequency resources to aggregate SL-PRS may be based on a received configuration from a network entity such as a gNB, location server, UE, etc., and/or based on a pre-configuration. In at least one implementation, a UE may request that the network provide a SL-PRS configuration including an aggregation of PRS resources in time and frequency, which may be based on periodic grant-based scheduling in terms of configuration grants including Type 1 and/or Type 2 based DCI activation/release (e.g., deactivation)) and/or dynamic grant-based scheduling. In implementations a UE may forward reserved SL-PRS configuration including time-frequency allocation including the SL-PRS resources to be aggregated based on a location service request, a type of positioning method, a number of anchor UE, or combinations thereof.

In implementations a configured UE/device within a sidelink positioning group may perform sensing and/or selection/reselection of resources for SL-PRS bandwidth aggregation on behalf of members within the sidelink positioning group. Further, the sidelink positioning group may be managed and defined by higher layers, examples of which are described throughout this disclosure. Resources used for SL-PRS bandwidth aggregation may be allocated based on SL-PRS sequence ID, source ID, destination ID, anchor ID, server UE ID, UE-specific ID, member ID, group ID, and combinations thereof. The configured UE/devices may direct share the reserved resources via lower layer signaling, e.g., SCI (1^{st} stage and/or 2^{nd} stage), MAC CE, or higher layer signaling, e.g., PC5 RRC, SLPP, PC5-S, etc.

In implementations a UE/device may sense and select SL-PRS resources as per a distributed sensing mechanism such as Mode 2 in sidelink communications and/or Scheme 2 in sidelink positioning. A UE/device may be configured to sense and reserve resources in one or more pools within a carrier and/or another carrier for the purposes of SL-PRS bandwidth aggregation.

In implementations a location server (e.g., LMF) may request a recommendation of SL-PRS resources to be reserved for SL-PRS bandwidth aggregation by the gNB and the gNB (e.g., NG-RAN including multiple gNBs and/or TRPs) may respond with the recommended resources and/or based on the location server request. This can be achieved, for instance, via NRPPa signaling and messaging between location server and gNB.

In implementations a transmitting UE may utilize SL-PRS transmit frequency hopping across resources such as in cases where a resource pool and/or SL-PRS bandwidth is limited. The frequency hopping may be performed across TRPs, BWP, resource pools, resource sets, resources, etc. Further, the frequency hopping may be performed across overlapping and/or non-overlapping frequency resources, e.g., PRB, sub-channels, etc. Further configuration details associated with SL-PRS include time gap between consecutive or non-consecutive hops (e.g., slot level), symbol-level granularities, number of hops, start PRB, start sub-channel of hops, etc.

In implementations a location server (e.g., LMF) initiated on-demand SL-PRS and/or UE/device initiated on-demand SL-PRS may be triggered to support SL-PRS bandwidth aggregation and/or SL-PRS transmitter (Tx)/Receiver (Rx) frequency hopping. In scenarios of LMF-initiated on-demand SL-PRS, an LMF may trigger an updated SL-PRS configuration request to the NG-RAN (e.g., gNB) for SL-PRS bandwidth aggregation or SL-PRS frequency hopping. In implementation such a scenario may override an existing similar configuration and/or may be a new configuration based on a change in positioning parameters received from higher layers, e.g., horizontal/vertical accuracy, absolute/relative accuracy, latency, reliability, etc.

In implementations activation and deactivation (e.g., release) signaling can be transmitted by a SL-PRS transmitting device/UE when performing SL-PRS bandwidth aggregation and/or SL-PRS Tx/Rx frequency hopping. The activation and deactivation may be provided by a third network entity, such as LMF, NG-RAN, gNB, and/or or UE, e.g., server UE, client UE, etc.

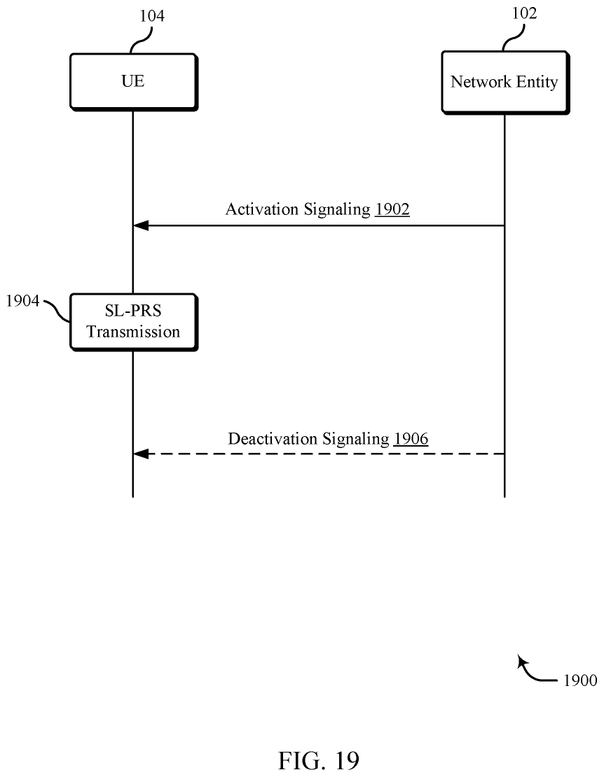

FIG. 19 illustrates a procedure 1900 that supports sidelink positioning using bandwidth aggregation in accordance with aspects of the present disclosure. The procedure 1900, for instance, represents a signaling flow for activation and deactivation signaling for SL-PRS bandwidth aggregation. In the procedure 1900 a network entity 102 (e.g., a gNB, LMF, and/or other network entity) transmits activation signaling 1902 to a UE 104, e.g., an anchor UE. The activation signaling 1902, for instance, activates for the UE 104 SL-PRS resources to transmit SL-PRS for bandwidth aggregation. The UE 104 performs SL-PRS transmission 1904 based at least in part on the activation signaling 1902. The SL-PRS transmission 1904, for instance, utilizes SL-PRS resources activated by the activation signaling 1902. The SL-PRS transmission 1904, for example, can include transmission across different carriers, BWP, resource pools, resource sets, resources, etc.

Further to the procedure 1900 the network entity 102 transmits deactivation signaling 1906 to deactivate the SL-PRS resources activated by the activation signaling 1902. The deactivation signaling 1906, for example, releases SL-PRS resources used by the UE 104 as part of the SL-PRS transmission 1904.

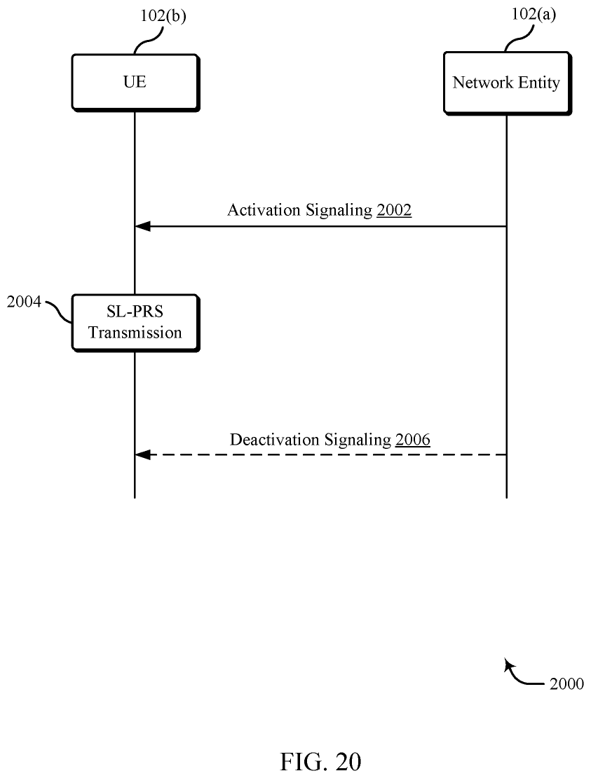

FIG. 20 illustrates a procedure 2000 that supports sidelink positioning using bandwidth aggregation in accordance with aspects of the present disclosure. The procedure 2000, for instance, represents a signaling flow for activation and deactivation signaling for SL-PRS bandwidth aggregation. In the procedure 2000 a UE 104(a) (e.g., a server UE) transmits activation signaling 2002 to a UE 104(b), e.g., an anchor UE. The activation signaling 2002, for instance, activates for the UE 104(b) SL-PRS resources to transmit SL-PRS for bandwidth aggregation. The UE 104(b) performs SL-PRS transmission 2004 based at least in part on the activation signaling 2002. The SL-PRS transmission 2004, for instance, utilizes SL-PRS resources activated by the activation signaling 2002. The SL-PRS transmission 2004, for example, can include transmission across different carriers, BWP, resource pools, resource sets, resources, etc.

Further to the procedure 2000 the UE 104(b) transmits deactivation signaling 2006 to deactivate the SL-PRS resources activated by the activation signaling 2002. The deactivation signaling 2006, for example, releases SL-PRS resources used by the UE 104(a) as part of the SL-PRS transmission 2004.

In implementations activation and deactivation signaling such as described in the procedures 1900, 2000 may be implemented via lower layer signaling (e.g., SCI (1st stage and/or 2nd stage), MAC CE, etc.) and/or higher layer signaling, e.g., PC5 RRC, SLPP, PC5-S, etc. In implementations a target UE may transmit SL-PRS such as based on a positioning technique, e.g., SL-RTT, SL-TDoA (SL-RSTD or SL-RTOA), etc. In implementations activation and deactivation signaling may be applied to SL-PRS Tx hopping such as based on an entity/UE performing the Tx hopping.

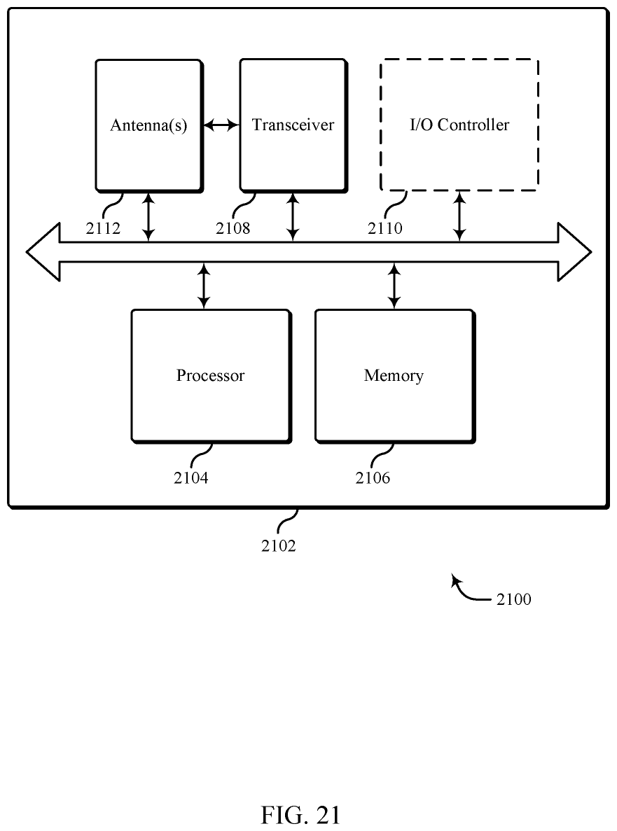

FIG. 21 illustrates an example of a block diagram 2100 of a device 2102 (e.g., an apparatus) that supports sidelink positioning using bandwidth aggregation in accordance with aspects of the present disclosure. The device 2102 may be an example of a network entity 102, a UE 104, and/or a combination thereof, such as described herein. The device 2102 may support wireless communication with one or more network entities 102, UEs 104, or any combination thereof. The device 2102 may include components for bi-directional communications including components for transmitting and receiving communications, such as a processor 2104, a memory 2106, a transceiver 2108, and an I/O controller 2110. These components may be in electronic communication or otherwise coupled (e.g., operatively, communicatively, functionally, electronically, electrically) via one or more interfaces (e.g., buses).

The processor 2104, the memory 2106, the transceiver 2108, or various combinations thereof or various components thereof may be examples of means for performing various aspects of the present disclosure as described herein. For example, the processor 2104, the memory 2106, the transceiver 2108, or various combinations or components thereof may support a method for performing one or more of the operations described herein.

In some implementations, the processor 2104, the memory 2106, the transceiver 2108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2104 and the memory 2106 coupled with the processor 2104 may be configured to perform one or more of the functions described herein (e.g., executing, by the processor 2104, instructions stored in the memory 2106). In the context of a network entity 102 and/or a UE 104, for example, the transceiver 2108 and the processor coupled 2104 coupled to the transceiver 2108 are configured to cause the network entity 102 and/or a UE 104 to perform the various described operations and/or combinations thereof.

For example, the processor 2104 and/or the transceiver 2108 may support wireless communication at the device 2102 in accordance with examples as disclosed herein. For instance, the processor 2104 and/or the transceiver 2108 may be configured as and/or otherwise support a means to receive a trigger event to perform SL-PRS bandwidth aggregation; generate an aggregated bandwidth based at least in part on an availability of time-frequency resources available to aggregate SL-PRS resources and based at least in part on the aggregated bandwidth corresponding to one or more conditions, the one or more conditions including at least one same SL-PRS configuration across different sidelink carriers; and transmit SL-PRS with the aggregated bandwidth.

Further, in some implementations, the processor is configured to cause the apparatus to receive the trigger event from one or more higher layers; the trigger event includes a message from at least one internal higher layer of the apparatus, the at least one internal higher layer of the apparatus including one or more of a MAC CE, a PC5 RRC layer, a sidelink positioning protocol layer, a vehicle to everything (V2X) layer, a proximity services (ProSe) layer, or an application layer; the trigger event includes a message from one or more of a gNB, a location server, an anchor user equipment (UE), a PRU UE, a server UE, client UE, or a target UE; the processor is configured to cause the apparatus to determine the availability of the time-frequency resources to aggregate SL-PRS based at least in part on configuration information received from a network entity, the network entity including a gNB, a location server, or a user equipment (UE); the processor is configured to cause the apparatus to determine the availability of the time-frequency resources to aggregate SL-PRS based at least in part on a preconfiguration of the apparatus.

Further, in some implementations, the at least one same SL-PRS configuration includes one or more of overlapping symbols from different sidelink carriers, different sidelink BWP, different sidelink Resource Pools, aligned periodicities across the different sidelink carriers, aligned sidelink PRS slot offsets across the different sidelink carriers, aligned comb-sizes, or aligned muting pattern; the aggregated bandwidth is applicable to one or more of intra-band contiguous sidelink carriers, intra-band non-contiguous sidelink carriers, or inter-band sidelink carriers; the trigger event causes the apparatus to transmit a SL-PRS aggregated bandwidth on-demand request; the processor is configured to cause the apparatus to generate the aggregated bandwidth based on one or more of sidelink carrier level, sidelink BWP level, sidelink dedicated resource pool level, sidelink shared resource pool level, or sidelink PRS resource level.

Further, in some implementations, the processor is configured to cause the apparatus to determine an availability of a plurality of time-frequency resources available to perform one or more of transmit frequency positioning reference signal hopping or receive frequency positioning reference signal hopping and based at least in part on a received configuration; the processor is configured to cause the apparatus to receive a second trigger event from one or more higher layers to perform the one or more of the transmit frequency positioning reference signal hopping or the receive frequency positioning reference signal hopping; the received configuration includes one or more of a resource granularity of hops, a time gap between one or more of consecutive hops or non-consecutive hops, a number of hops, a start PRB of hops, or a start sub-channel of hops; the resource granularity of hops includes one or more of SL-PRS resource, SL-PRS resource set, SL-PRS dedicated or shared resource pool, sidelink BWP, or sidelink carrier; a subset of parameters within the at least one same SL-PRS configuration across different sidelink carriers is the same, and the subset of parameters includes a part of the one or more conditions.

In a further example, the processor 2104 and/or the transceiver 2108 may support wireless communication at the device 2102 in accordance with examples as disclosed herein. The processor 2104 and/or the transceiver 2108, for instance, may be configured as or otherwise support a means for receiving a trigger event to perform SL-PRS bandwidth aggregation; generating an aggregated bandwidth based at least in part on an availability of time-frequency resources available to aggregate SL-PRS resources and based at least in part on the aggregated bandwidth corresponding to one or more conditions, the one or more conditions including at least one same SL-PRS configuration across different sidelink carriers; and transmitting SL-PRS with the aggregated bandwidth.

Further, in some implementations, receiving the trigger event from one or more higher layers; where the trigger event includes a message from at least one internal higher layer of an apparatus, the at least one internal higher layer of the apparatus including one or more of a MAC CE, a PC5 RRC layer, a sidelink positioning protocol layer, a vehicle to everything (V2X) layer, a proximity services (ProSe) layer, or an application layer; where the trigger event includes a message from one or more of a gNB, a location server, an anchor user equipment (UE), a PRU UE, a server UE, client UE, or a target UE; further including determining the availability of the time-frequency resources to aggregate SL-PRS based at least in part on configuration information received from a network entity, the network entity including a gNB, a location server, or a user equipment (UE); further including determining the availability of the time-frequency resources to aggregate SL-PRS based at least in part on a preconfiguration of an apparatus.

Further, in some implementations, the at least one same SL-PRS configuration includes one or more of overlapping symbols from different sidelink carriers, different sidelink BWP, different sidelink Resource Pools, aligned periodicities across the different sidelink carriers, aligned sidelink PRS slot offsets across the different sidelink carriers, aligned comb-sizes, or aligned muting pattern; where the aggregated bandwidth is applicable to one or more of intra-band contiguous sidelink carriers, intra-band non-contiguous sidelink carriers, or inter-band sidelink carriers; where the trigger event causes transmission of a SL-PRS aggregated bandwidth on-demand request; further including generating the aggregated bandwidth based on one or more of sidelink carrier level, sidelink BWP level, sidelink dedicated resource pool level, sidelink shared resource pool level, or sidelink PRS resource level.

Further, in some implementations, determining an availability of a plurality of time-frequency resources available to perform one or more of transmit frequency positioning reference signal hopping or receive frequency positioning reference signal hopping and based at least in part on a received configuration; further including receiving a second trigger event from one or more higher layers to perform the one or more of the transmit frequency positioning reference signal hopping or the receive frequency positioning reference signal hopping; the received configuration includes one or more of a resource granularity of hops, a time gap between one or more of consecutive hops or non-consecutive hops, a number of hops, a start PRB of hops, or a start sub-channel of hops; the resource granularity of hops includes one or more of SL-PRS resource, SL-PRS resource set, SL-PRS dedicated or shared resource pool, sidelink BWP, or sidelink carrier; a subset of parameters within the at least one same SL-PRS configuration across different sidelink carriers is the same, and the subset of parameters includes a part of the one or more conditions.

In a further, the processor 2104 and/or the transceiver 2108 may support wireless communication at the device 2102 in accordance with examples as disclosed herein. For instance, the processor 2104 and/or the transceiver 2108 may be configured as and/or otherwise support a means to transmit activation signaling to activate SL-PRS resources for transmitting SL-PRS for bandwidth aggregation; and transmit deactivation signaling to deactivate the activated SL-PRS resources.

Further, in some implementations, the apparatus includes one or more of a network entity or a user equipment (UE); where the processor is configured to cause the apparatus to transmit at least one of the activation signaling or the deactivation signaling via one or more of lower layer signaling or higher layer signaling.

In a further example, the processor 2104 and/or the transceiver 2108 may support wireless communication at the device 2102 in accordance with examples as disclosed herein. The processor 2104 and/or the transceiver 2108, for instance, may be configured as or otherwise support a means for transmitting activation signaling to activate SL-PRS resources for transmitting SL-PRS for bandwidth aggregation; and transmitting deactivation signaling to deactivate the activated SL-PRS resources.

Further, in some implementations, operations are performed by an apparatus, and the apparatus includes one or more of a network entity or a user equipment (UE); further including transmitting at least one of the activation signaling or the deactivation signaling via one or more of lower layer signaling or higher layer signaling.

In a further, the processor 2104 and/or the transceiver 2108 may support wireless communication at the device 2102 in accordance with examples as disclosed herein. For instance, the processor 2104 and/or the transceiver 2108 may be configured as and/or otherwise support a means to receive activation signaling to activate SL-PRS resources for transmitting SL-PRS for bandwidth aggregation; transmit, based at least in part on the activation signaling, SL-PRS via an aggregated bandwidth; and receive deactivation signaling to deactivate the activated sidelink PRS resources.

Further, in some implementations, the processor is configured to cause the apparatus to receive at least one of the activation signaling or the deactivation signaling via one or more of lower layer signaling or higher layer signaling.

In a further example, the processor 2104 and/or the transceiver 2108 may support wireless communication at the device 2102 in accordance with examples as disclosed herein. The processor 2104 and/or the transceiver 2108, for instance, may be configured as or otherwise support a means for receiving activation signaling to activate SL-PRS resources for transmitting SL-PRS for bandwidth aggregation; transmitting, based at least in part on the activation signaling, SL-PRS via an aggregated bandwidth; and receiving deactivation signaling to deactivate the activated sidelink PRS resources.

Further, in some implementations, operations further include receiving at least one of the activation signaling or the deactivation signaling via one or more of lower layer signaling or higher layer signaling.

In a further example, the processor 2104 and/or the transceiver 2108 may support wireless communication at the device 2102 in accordance with examples as disclosed herein. For instance, the processor 2104 and/or the transceiver 2108 may be configured as and/or otherwise support a means to transmit a trigger event to perform SL-PRS bandwidth aggregation; receive SL-PRS via an aggregated bandwidth, the aggregated bandwidth corresponding to at least one same SL-PRS configuration across different sidelink carriers; and perform aggregated SL-PRS positioning measurements based on the received configuration.

Further, in some implementations, the processor is configured to cause the apparatus to transmit the trigger event via higher layer signaling; the processor is configured to cause the apparatus to transmit the trigger event via one or more of a MAC CE, PC5 RRC signaling, sidelink positioning protocol signaling, vehicle to everything (V2X) signaling, proximity services (ProSe) signaling, or application signaling; the apparatus includes one of a gNB, a location server, an anchor user equipment (UE), a PRU UE, a server UE, or a target UE; the processor is configured to cause the apparatus to transmit configuration information for determining availability of time-frequency resources for aggregating SL-PRS; the processor is configured to cause the apparatus to transmit configuration information for determining an availability of a plurality of time-frequency resources available to perform one or more of transmit frequency positioning reference signal hopping or receive frequency positioning reference signal hopping; the processor is configured to cause the apparatus to transmit a second trigger event to perform the one or more of the transmit frequency positioning reference signal hopping or the receive frequency positioning reference signal hopping; the configuration information includes one or more of a resource granularity of hops, a time gap between one or more of consecutive hops or non-consecutive hops, a number of hops, a start PRB of hops, or a start sub-channel of hops.

In a further example, the processor 2104 and/or the transceiver 2108 may support wireless communication at the device 2102 in accordance with examples as disclosed herein. The processor 2104 and/or the transceiver 2108, for instance, may be configured as or otherwise support a means for transmitting a trigger event to perform SL-PRS bandwidth aggregation; receiving SL-PRS via an aggregated bandwidth, the aggregated bandwidth corresponding to at least one same SL-PRS configuration across different sidelink carriers; and performing aggregated SL-PRS positioning measurements based on the received configuration.

Further, in some implementations, operations further include transmitting the trigger event via higher layer signaling; further including transmitting the trigger event via one or more of a MAC CE, PC5 RRC signaling, sidelink positioning protocol signaling, vehicle to everything (V2X) signaling, proximity services (ProSe) signaling, or application signaling; the method is performed by an apparatus, and the apparatus includes one of a gNB, a location server, an anchor user equipment (UE), a PRU UE, a server UE, or a target UE; further including transmitting configuration information for determining availability of time-frequency resources for aggregating SL-PRS; further including transmitting configuration information for determining an availability of a plurality of time-frequency resources available to perform one or more of transmit frequency positioning reference signal hopping or receive frequency positioning reference signal hopping; further including transmitting a second trigger event to perform the one or more of the transmit frequency positioning reference signal hopping or the receive frequency positioning reference signal hopping; the configuration information includes one or more of a resource granularity of hops, a time gap between one or more of consecutive hops or non-consecutive hops, a number of hops, a start PRB of hops, or a start sub-channel of hops.

The processor 2104 of the device 2102 may support wireless communication in accordance with examples as disclosed herein. The processor 2104 includes at least one controller coupled with at least one memory, and the at least one controller is configured to and/or operable to cause the processor to receive a trigger event to perform SL-PRS bandwidth aggregation; generate an aggregated bandwidth based at least in part on an availability of time-frequency resources available to aggregate SL-PRS resources and based at least in part on the aggregated bandwidth corresponding to one or more conditions, the one or more conditions comprising at least one same SL-PRS configuration across different sidelink carriers; and transmit SL-PRS with the aggregated bandwidth. Further, the controller is configured to and/or operable to cause the processor 2104 to perform any one or more of the operations described herein, such as with reference to the device 2102.

The processor 2104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2104 may be configured to operate a memory array using a memory controller. In some other implementations, a memory controller may be integrated into the processor 2104. The processor 2104 may be configured to execute computer-readable instructions stored in a memory (e.g., the memory 2106) to cause the device 2102 to perform various functions of the present disclosure.

The memory 2106 may include random access memory (RAM) and read-only memory (ROM). The memory 2106 may store computer-readable, computer-executable code including instructions that, when executed by the processor 2104 cause the device 2102 to perform various functions described herein. The code may be stored in a non-transitory computer-readable medium such as system memory or another type of memory. In some implementations, the code may not be directly executable by the processor 2104 but may cause a computer (e.g., when compiled and executed) to perform functions described herein. In some implementations, the memory 2106 may include, among other things, a basic I/O system (BIOS) which may control basic hardware or software operation such as the interaction with peripheral components or devices.

The I/O controller 2110 may manage input and output signals for the device 2102. The I/O controller 2110 may also manage peripherals not integrated into the device M02. In some implementations, the I/O controller 2110 may represent a physical connection or port to an external peripheral. In some implementations, the I/O controller 2110 may utilize an operating system such as iOS®, ANDROID®, MS-DOS®, MS-WINDOWS®, OS/2®, UNIX®, LINUX®, or another known operating system. In some implementations, the I/O controller 2110 may be implemented as part of a processor, such as the processor M08. In some implementations, a user may interact with the device 2102 via the I/O controller 2110 or via hardware components controlled by the I/O controller 2110.

In some implementations, the device 2102 may include a single antenna 2112. However, in some other implementations, the device 2102 may have more than one antenna 2112 (e.g., multiple antennas), including multiple antenna panels or antenna arrays, which may be capable of concurrently transmitting or receiving multiple wireless transmissions. The transceiver 2108 may communicate bi-directionally, via the one or more antennas 2112, wired, or wireless links as described herein. For example, the transceiver 2108 may represent a wireless transceiver and may communicate bi-directionally with another wireless transceiver. The transceiver 2108 may also include a modem to modulate the packets, to provide the modulated packets to one or more antennas 2112 for transmission, and to demodulate packets received from the one or more antennas 2112.

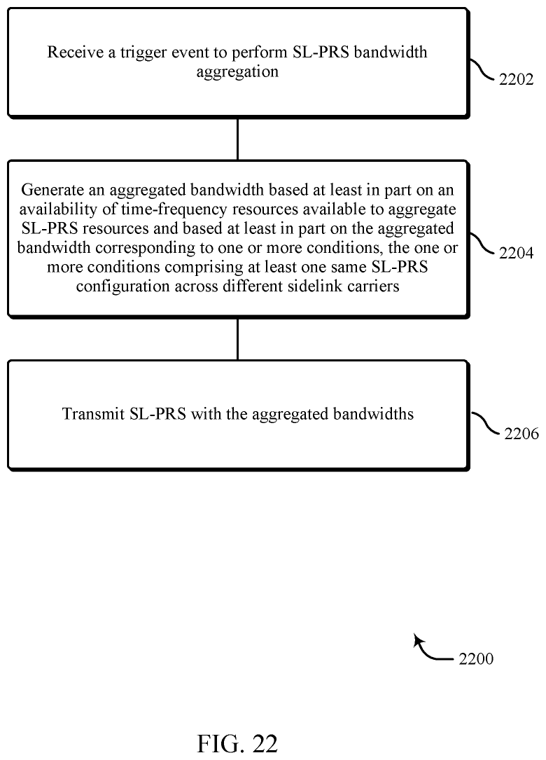

FIG. 22 illustrates a flowchart of a method 2200 that supports sidelink positioning using bandwidth aggregation in accordance with aspects of the present disclosure. The operations of the method 2200 may be implemented by a device or its components as described herein. For example, the operations of the method 2200 may be performed by a network entity 102, a UE 104, or combinations thereof, such as described with reference to FIGS. 1 through 21. In some implementations, the device may execute a set of instructions to control the function elements of the device to perform the described functions. Additionally, or alternatively, the device may perform aspects of the described functions using special-purpose hardware.

At 2202, the method may include receiving a trigger event to perform SL-PRS bandwidth aggregation. The operations of 2202 may be performed in accordance with examples as described herein. In some implementations, aspects of the operations of 2202 may be performed by a device as described with reference to FIG. 1.

At 2204, the method may include generating an aggregated bandwidth based at least in part on an availability of time-frequency resources available to aggregate SL-PRS resources and based at least in part on the aggregated bandwidth corresponding to one or more conditions, the one or more conditions comprising at least one same SL-PRS configuration across different sidelink carriers. The operations of 2204 may be performed in accordance with examples as described herein. In some implementations, aspects of the operations of 2204 may be performed by a device as described with reference to FIG. 1.

At 2206, the method may include transmitting SL-PRS with the aggregated band. The operations of 2206 may be performed in accordance with examples as described herein. In some implementations, aspects of the operations of 2206 may be performed by a device as described with reference to FIG. 1.

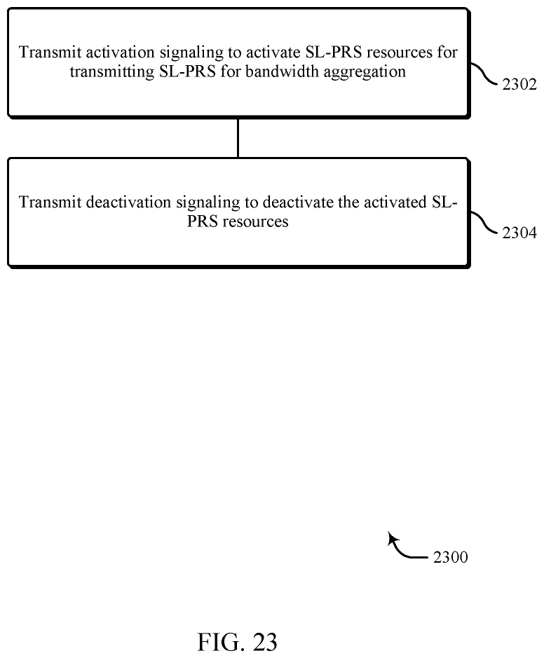

FIG. 23 illustrates a flowchart of a method 2300 that supports sidelink positioning using bandwidth aggregation in accordance with aspects of the present disclosure. The operations of the method 2300 may be implemented by a device or its components as described herein. For example, the operations of the method 2300 may be performed by a network entity 102, a UE 104, or combinations thereof, such as described with reference to FIGS. 1 through 21. In some implementations, the device may execute a set of instructions to control the function elements of the device to perform the described functions. Additionally, or alternatively, the device may perform aspects of the described functions using special-purpose hardware.

At 2302, the method may include transmitting activation signaling to activate SL-PRS resources for transmitting SL-PRS for bandwidth aggregation. The operations of 2302 may be performed in accordance with examples as described herein. In some implementations, aspects of the operations of 2302 may be performed by a device as described with reference to FIG. 1.

At 2304, the method may include transmitting deactivation signaling to deactivate the activated SL-PRS resources. The operations of 2304 may be performed in accordance with examples as described herein. In some implementations, aspects of the operations of 2304 may be performed by a device as described with reference to FIG. 1.

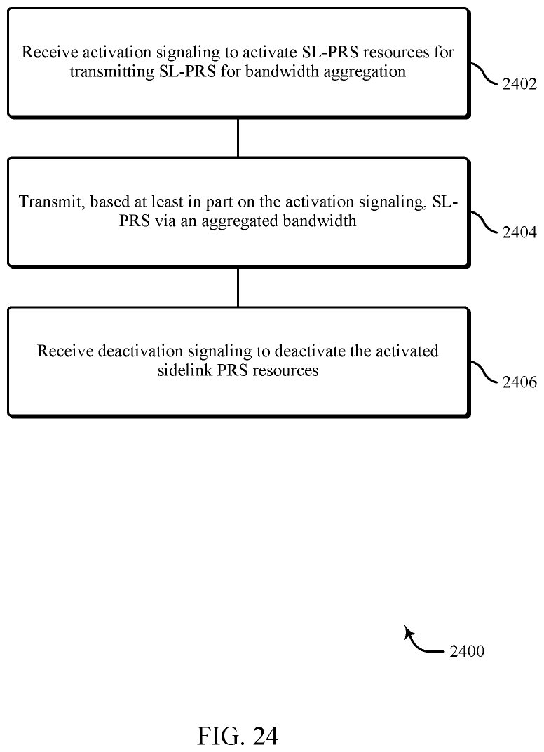

FIG. 24 illustrates a flowchart of a method 2400 that supports sidelink positioning using bandwidth aggregation in accordance with aspects of the present disclosure. The operations of the method 2400 may be implemented by a device or its components as described herein. For example, the operations of the method 2400 may be performed by a network entity 102, a UE 104, or combinations thereof, such as described with reference to FIGS. 1 through 21. In some implementations, the device may execute a set of instructions to control the function elements of the device to perform the described functions. Additionally, or alternatively, the device may perform aspects of the described functions using special-purpose hardware.

At 2402, the method may include receiving activation signaling to activate SL-PRS resources for transmitting SL-PRS for bandwidth aggregation. The operations of 2402 may be performed in accordance with examples as described herein. In some implementations, aspects of the operations of 2402 may be performed by a device as described with reference to FIG. 1.

At 2404, the method may include transmitting, based at least in part on the activation signaling, SL-PRS via an aggregated bandwidth. The operations of 2404 may be performed in accordance with examples as described herein. In some implementations, aspects of the operations of 2404 may be performed by a device as described with reference to FIG. 1.

At 2406, the method may include receiving deactivation signaling to deactivate the activated sidelink PRS resources. The operations of 2406 may be performed in accordance with examples as described herein. In some implementations, aspects of the operations of 2406 may be performed by a device as described with reference to FIG. 1.

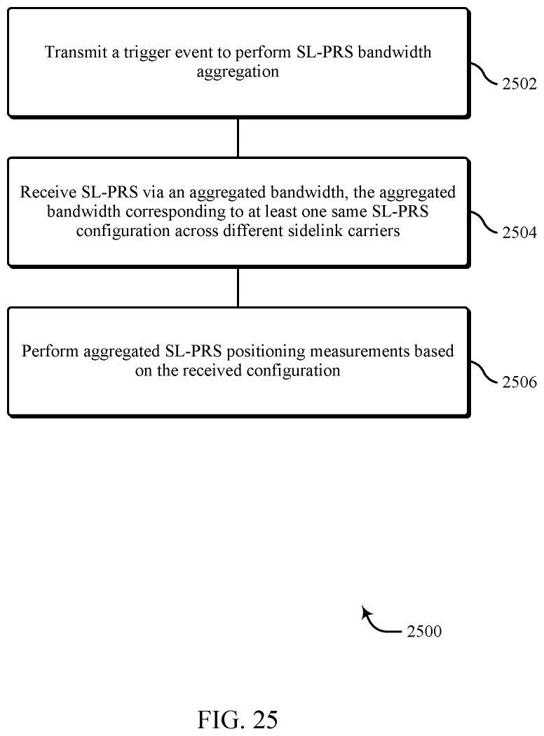

FIG. 25 illustrates a flowchart of a method 2500 that supports sidelink positioning using bandwidth aggregation in accordance with aspects of the present disclosure. The operations of the method 2500 may be implemented by a device or its components as described herein. For example, the operations of the method 2500 may be performed by a network entity 102, a UE 104, or combinations thereof, such as described with reference to FIGS. 1 through 21. In some implementations, the device may execute a set of instructions to control the function elements of the device to perform the described functions. Additionally, or alternatively, the device may perform aspects of the described functions using special-purpose hardware.

At 2502, the method may include transmitting a trigger event to perform SL-PRS bandwidth aggregation. The operations of 2502 may be performed in accordance with examples as described herein. In some implementations, aspects of the operations of 2502 may be performed by a device as described with reference to FIG. 1.

At 2504, the method may include receiving SL-PRS via an aggregated bandwidth, the aggregated bandwidth corresponding to at least one same SL-PRS configuration across different sidelink carriers. The operations of 2504 may be performed in accordance with examples as described herein. In some implementations, aspects of the operations of 2504 may be performed by a device as described with reference to FIG. 1.

At 2506, the method may include performing aggregated SL-PRS positioning measurements based on the received configuration. The operations of 2506 may be performed in accordance with examples as described herein. In some implementations, aspects of the operations of 2506 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
receive a trigger event to perform sidelink positioning reference signal (SL-PRS) bandwidth aggregation;
generate an aggregated bandwidth based at least in part on an availability of time-frequency resources available to aggregate SL-PRS resources and based at least in part on the aggregated bandwidth corresponding to one or more conditions, the one or more conditions comprising at least one same SL-PRS configuration across different sidelink carriers; and
transmit SL-PRS with the aggregated bandwidth.

2. The apparatus of claim 1, wherein the at least one processor is operable to cause the apparatus to receive the trigger event from one or more higher layers.

3. The apparatus of claim 1, wherein the trigger event comprises a message from at least one internal higher layer of the apparatus, the at least one internal higher layer of the apparatus comprising one or more of a media access control (MAC) control element (CE), a PC5 radio resource control (RRC) layer, a sidelink positioning protocol layer, a vehicle to everything (V2X) layer, a proximity services (ProSe) layer, or an application layer.

4. The apparatus of claim 1, wherein the trigger event comprises a message from one or more of a gNB, a location server, an anchor user equipment (UE), a positioning reference unit (PRU) UE, a server UE, client UE, or a target UE.

5. The apparatus of claim 1, wherein the at least one processor is operable to cause the apparatus to determine the availability of the time-frequency resources to aggregate SL-PRS based at least in part on configuration information received from a network entity, the network entity comprising a gNB, a location server, or a user equipment (UE).

6. The apparatus of claim 1, wherein the at least one processor is operable to cause the apparatus to determine the availability of the time-frequency resources to aggregate SL-PRS based at least in part on a preconfiguration of the apparatus.

7. The apparatus of claim 1, wherein the at least one same SL-PRS configuration comprises one or more of overlapping symbols from different sidelink carriers, different sidelink bandwidth parts (BWP), different sidelink Resource Pools, aligned periodicities across the different sidelink carriers, aligned SL-PRS slot offsets across the different sidelink carriers, aligned comb-sizes, or aligned muting pattern.

8. The apparatus of claim 1, wherein the aggregated bandwidth is applicable to one or more of intra-band contiguous sidelink carriers, intra-band non-contiguous sidelink carriers, or inter-band sidelink carriers.

9. The apparatus of claim 1, wherein the trigger event causes the apparatus to transmit a SL-PRS aggregated bandwidth on-demand request.

10. The apparatus of claim 1, wherein the at least one processor is operable to cause the apparatus to generate the aggregated bandwidth based on one or more of sidelink carrier level, sidelink bandwidth part (BWP) level, sidelink dedicated resource pool level, sidelink shared resource pool level, or SL-PRS resource level.

11. The apparatus of claim 1, wherein the at least one processor is operable to cause the apparatus to determine an availability of a plurality of time-frequency resources available to perform one or more of transmit frequency positioning reference signal hopping or receive frequency positioning reference signal hopping and based at least in part on a received configuration.

12. The apparatus of claim 11, wherein the at least one processor is operable to cause the apparatus to receive a second trigger event from one or more higher layers to perform the one or more of the transmit frequency positioning reference signal hopping or the receive frequency positioning reference signal hopping.

13. The apparatus of claim 11, wherein the received configuration comprises one or more of a resource granularity of hops, a time gap between one or more of consecutive hops or non-consecutive hops, a number of hops, a start physical resource block (PRB) of hops, or a start sub-channel of hops.

14. The apparatus of claim 13, the resource granularity of hops comprises one or more of SL-PRS resource, SL-PRS resource set, SL-PRS dedicated or shared resource pool, sidelink BWP, or sidelink carrier.

15. The apparatus of claim 1, wherein a subset of parameters within the at least one same SL-PRS configuration across different sidelink carriers is the same, and wherein the subset of parameters comprises a part of the one or more conditions.

16. An apparatus for wireless communication, comprising:
at least one memory; and
at least one processor coupled with the at least one memory and operable to cause the apparatus to:
receive activation signaling to activate sidelink positioning reference signal (SL-PRS) resources for transmitting SL-PRS for bandwidth aggregation;
transmit, based at least in part on the activation signaling, SL-PRS via an aggregated bandwidth; and
receive deactivation signaling to deactivate the activated SL-PRS resources.

17. An apparatus comprising:
a processor; and
a memory coupled to the processor, the processor operable to cause the apparatus to:
transmit a trigger event to perform sidelink positioning reference signal (SL-PRS) bandwidth aggregation;
receive SL-PRS via an aggregated bandwidth, the aggregated bandwidth corresponding to at least one same SL-PRS configuration across different sidelink carriers; and
perform aggregated SL-PRS positioning measurements based on the received configuration.

18. (canceled)

19. (canceled)

20. (canceled)

21. A method performed by an apparatus, the method comprising:
receiving a trigger event to perform sidelink positioning reference signal (SL-PRS) bandwidth aggregation;
generating an aggregated bandwidth based at least in part on an availability of time-frequency resources available to aggregate SL-PRS resources and based at least in part on the aggregated bandwidth corresponding to one or more conditions, the one or more conditions comprising at least one same SL-PRS configuration across different sidelink carriers; and
transmitting SL-PRS with the aggregated bandwidth.

22. The method of claim 21, further comprising:
receiving the trigger event from one or more higher layers.

23. The method of claim 21, wherein the trigger event comprises a message from at least one internal higher layer of the apparatus, the at least one internal higher layer of the apparatus comprising one or more of a media access control (MAC) control element (CE), a PC5 radio resource control (RRC) layer, a sidelink positioning protocol layer, a vehicle to everything (V2X) layer, a proximity services (ProSe) layer, or an application layer.
